(19) United States
(12) Patent Application Publication
(10) Pub. No.: US 2009/0009547 A1
(43) Pub. Date: Jan. 8, 2009

(54) Print control device, printing device, print control method, program, and data structure

(76) Inventors: Hiroshi Udagawa, Tokyo (JP); Masato Nakamura, Kanagawa (JP); Takumi Namekawa, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/659,293

(22) PCT Filed: Aug. 11, 2005
(86) PCT No.: PCT/JP2005/014755

§ 371 Date: Feb. 1, 2007

(30) Foreign Application Priority Data
Aug. 12, 2004 (JP) 2004-234988
Aug. 12, 2004 (JP) 2004-234990

(51) Int. Cl. B41J 29/38; H04N 1/46

(52) U.S. Cl. 347/12; 358/534

(57) ABSTRACT

When print data having a low resolution is selected with priority to print speed, it is inevitable that the print quality is deteriorated. Thus, in order to solve the above-described problem, a print controller for controlling a print head having k lines of nozzle arrays or more corresponding to k kinds of (k is a natural number of two or more) ink having different densities includes: (a) a resolution determination section for determining whether print data having a resolution 1/n times (n is a natural number of two or more) a nozzle pitch has been given, and (b) when an affirmative result is obtained by the resolution determination section, an output-pattern allocation section for allocating, to a quantized value corresponding to each pixel, an output pattern including n-row×n-column dots and relating one of k kinds of ink having different densities or no ejection to each dot.

### TECHNICAL FIELD

The present invention relates to a print controller for controlling an ink-ejection method printer, a printer including the print controller, a method of controlling print for providing a print control function, a program for achieving the print control function, and a data structure for achieving the print control function.

### BACKGROUND ART

Nowadays, an ink-jet method printer is demanded to have very high print quality. For example, the printer is demanded to have the same print quality as that of a silver film photograph.

With this, the diameter of a dot as a minimum unit constituting one pixel becomes very small. Also, a plurality of kinds of ink having different densities is used in order to improve the gradation expression and to decrease the granularity.

Known printing techniques disclosed in Japanese Unexamined Patent Application Publication No. 2003-237111, Japanese Unexamined Patent Application Publication No. 2002-171407, Japanese Unexamined Patent Application Publication No. 2001-225488, etc., are sufficient for printing images with very high quality.

However, in general, in order to achieve high print quality, it is necessary to have print data having a high resolution and a very long printing time. Thus, when a short printing time is demanded, the resolution of the print data is often decreased.

FIG. 1 illustrates examples of the dot configurations of individual pixels corresponding to two kinds of resolutions. FIG. 1(A) corresponds to the print result when printing is carried out with a resolution determined by a nozzle pitch. FIG. 1(B) corresponds to the print result when printing is carried out with a resolution ½ times a nozzle pitch.

FIG. 2 illustrates an example of print using two kinds of ink having different densities. In this regard, FIG. 2 is the example of print when print data having a resolution of 300 dpi is printed using a print head having a nozzle pitch of 600 dpi.

In FIG. 2, the gradation of each pixel is expressed by three kinds of dots, without a dot, a dot by low-density ink, and a dot by high-density ink. In this regard, FIG. 2 shows the case of applying three-valued error-diffusion processing to the print data. Also, FIG. 3 illustrates an enlarged partial area of the print result shown in FIG. 2.

In the known technique, the same signal processing is applied as the case of processing the print data of a maximum resolution regardless of a difference in the resolution of print data. That is to say, the result of the three-valued error-diffusion processing is related regardless of a difference in the pixel size.

For the purpose of reference, FIG. 4(A) illustrates an example of a dot-allocation table (for three-valued gradation) to be allocated to the quantized values after error diffusion.

In the case of FIG. 4(A), the upper four bits (B7 to B4) of the output pattern correspond to low-density ink, and the lower four bits (B3 to B0) correspond to high-density ink.

The numeric value “0” included in the table of FIG. 4(A) denotes without dot, and the numeric value “1” denotes with dot. FIG. 4(B) illustrates a dot pattern when the quantized value is “1”, and FIG. 4(C) illustrates a dot pattern when the quantized value is “2”.

Here, the quantized value “1” corresponds to low-density dots (all the four dots are low-density dots), and the quantized value is “2” corresponds to high-density dots (all the four dots are low-density dots).

In this manner, when printing is carried out with a resolution of 300 dpi using a print head having a nozzle pitch of 600 dpi, a three-valued output pattern is allocated to one pixel formed by four dots.

That is to say, three kinds of output patterns, without dot, a low-density dot, and a high-density dot are allocated.

In this case, the size of one pixel becomes four times the print size of high resolution. As a result, when print data of low resolution is used, granularity and pseudo-contours are apt to occur in the print result.

In this manner, in the case of a known apparatus, there is a one-to-one relationship between the print quality and the resolution of the print data.

Accordingly, it has the same meaning to select print data having a low resolution with priority to print speed as to allow the deterioration of the print quality.

### DISCLOSURE OF INVENTION

The present inventor proposes the following technical method on the basis of the recognition of the above facts.

As an embodiment of the invention, there is proposed a print controller having (a) a resolution determination section for determining whether print data having a resolution 1/n times (n is a natural number of two or more) a nozzle pitch has been given, and (b) when an affirmative result is obtained by the resolution determination section, an output-pattern allocation section for allocating, to a quantized value corresponding to each pixel, an output pattern including n-row×n-column dots and relating one of k kinds of ink having different densities or no ejection to each dot.

The print controller here includes the control of a print head having k lines of nozzle arrays or more corresponding to k kinds of (k is a natural number of two or more) ink having different densities.

This print controller adopts a method in which when print data having a resolution 1/n times a nozzle pitch has been given, an output pattern allowing the same gradation expression as the case of giving print data having a resolution equal to the nozzle pitch is allocated.

That is to say, the print controller adopts a method in which one pixel is related to n×n dots, and ink having different densities is sprayed onto each dot in order to express multi-valued and multi-gradation.

In this regard, the print controller is desirably provided with a distribution section for distributing data portions, which are partial data of the output pattern and corresponding to k kinds of ink, to each of the corresponding nozzle arrays. The distribution section may be disposed in the output-pattern allocation section, or may be disposed at the subsequent stage of the output-pattern allocation section.

By providing the distribution section, k output-pattern allocation sections for individual ink densities are not necessarily disposed.

That is to say, the circuit configuration for each of the k kinds of ink can be commonly disposed. Thus, the circuit size can be reduced, and at the same time, the simplification of the circuit configuration can be achieved.

Also, in the print controller, the output-pattern allocation section is desirably disposed for each signal system of each color for color printing and for black. Each color for color printing is generally referred to as three colors, cyan series, magenta series, and yellow series. For each color of color printing, by applying the above-described output-pattern allocation section densities, it becomes possible to print the print data having a low resolution with a high gradation expression.

Also, the print controller is desirably provided with an additional-information determination section for selecting the allocation of output patterns by the output-pattern allocation section when printing with n times resolution is instructed to the additional information of the print data having a resolution 1/n times a nozzle pitch. By adopting the additional-information determination section, it is possible to achieve the selection of print quality by the user.

In this regard, the above-described technique is not limited to a print controller, but can be achieved as a printer, a method of print control, a program, and a data structure of an output pattern.

By using the present invention, even when print data having a low resolution compared with the maximum resolution that the print head can reproduce is given from an external apparatus (information processing apparatus), it is possible to obtain a print result having a high gradation expression.

Also, print data having a low resolution can be directly processed as far as the output-pattern allocation processing. Thus, the communication load and signal processing load becomes small. As a result, the reduction of the printing time can be achieved.

### BRIEF DESCRIPTION OF THE DRAWINGS

FIG. 1(A) is a diagram illustrating a relationship of a pixel size with a resolution.

FIG. 1(B) is a diagram illustrating a relationship of a pixel size with a resolution.

FIG. 2 is a diagram illustrating a print example of the print data having a resolution half the maximum resolution of a print head.

FIG. 3 is a diagram illustrating an enlarged partial area of the print example shown in FIG. 2.

FIG. 4 is a diagram illustrating an example of a dot-allocation table for three-valued error diffusion.

FIG. 5 is a diagram illustrating an example of the configuration of a nozzle face of a print head of a first embodiment.

FIG. 6 is a diagram illustrating an example of output patterns using two kinds of ink, dark and light.

FIG. 7 is a diagram illustrating an example of nine kinds of output patterns used in the embodiment.

FIG. 8 is a diagram illustrating a density-reproducing characteristic in the nine kinds of output patterns shown in FIG. 7.

FIG. 9 is a diagram illustrating an example of a gamma correction curve used in the embodiment.

FIG. 10 is a diagram illustrating an example of the configuration of the printer (print controller) in the first embodiment.

FIG. 11 is a diagram illustrating an example of the configuration of a halftoning section.

FIG. 12 is a diagram illustrating a processing image of a gradation transfer section and a quantization section.

FIG. 13 is a diagram illustrating an example of a dot-allocation table for nine-valued error diffusion.

FIG. 14 is a diagram illustrating a processing image of an output-pattern allocation section.

FIG. 15 is a diagram illustrating a print example in the case where a print technique according to the embodiment is applied when print data having a resolution half the maximum resolution of the print head has been input.

FIG. 16 is a diagram illustrating an enlarged partial area of the example of the print shown in FIG. 15.

FIG. 17 is a diagram illustrating a nozzle face of a line head of a second embodiment.

FIG. 18 is a diagram illustrating an example of a dot array forming one pixel.

FIG. 19 is a diagram illustrating the case where all four dots forming one pixel are formed by light ink.

FIG. 20 is a diagram illustrating the case where three out of the four dots forming one pixel are formed by light ink and one is formed by dark ink.

FIG. 21 is a diagram illustrating the case where two out of the four dots forming one pixel are formed by light ink and two are formed by dark ink.

FIG. 22 is a diagram illustrating the case where one out of the four dots forming one pixel is formed by light ink and three are formed by dark ink.

FIG. 23 is a diagram illustrating the case where all the four dots forming one pixel are formed by light ink.

FIG. 24 is a tabular representation illustrating a relationship between dot patterns and the number of densities that can be represented.

FIG. 25 is a diagram illustrating a density-reproducing characteristic of a dot pattern.

FIG. 26 is a diagram illustrating a gamma correction curve of the density-reproducing characteristic.

FIG. 27 is a diagram illustrating an embodiment of a printer in the second embodiment.

FIG. 28 is a diagram illustrating a relationship between dots stored in a dot-pattern conversion section and the number of ink droplets.

FIG. 29 is a diagram illustrating a corresponding relationship between a dot pattern and an output buffer for each density.

FIG. 30 is a diagram illustrating an example of a print result of one pixel.

FIG. 31 is a diagram illustrating another embodiment of a printer in the second embodiment.

FIG. 32 is a diagram illustrating another embodiment of a printer in the second embodiment.

FIG. 33(A) is a diagram illustrating an example of an input/output characteristic of a gradation width conversion section.

FIG. 33(B) is a diagram illustrating an example of an input/output characteristic of a gradation width conversion section.

FIG. 33(C) is a diagram illustrating an example of an input/output characteristic of a gradation width conversion section.

FIG. 34 is a diagram illustrating an example of dot formation by deflection ejection.

FIG. 35 is a diagram illustrating another embodiment of a nozzle face constituting a line head.

FIG. 36 is a diagram illustrating another embodiment of a printer in the second embodiment.

FIG. 37 is a diagram illustrating an example of distribution of nozzle drive data.

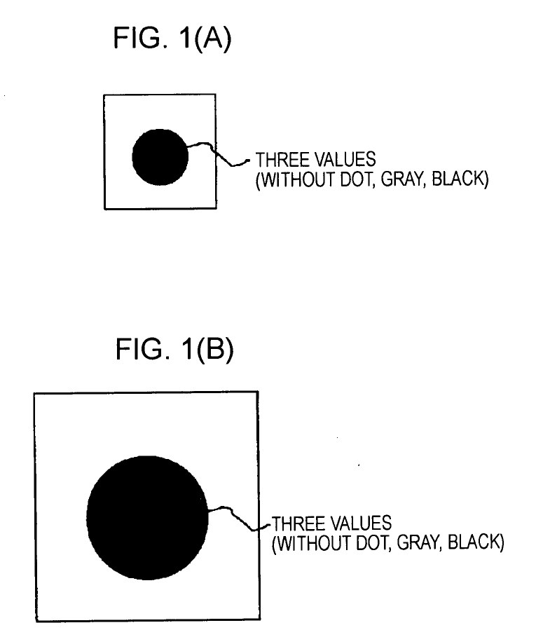

### BEST MODE FOR CARRYING OUT THE INVENTION

In the following, a description will be given of a first embodiment of the present invention.

In this regard, known or publicly known techniques in that technical field are applied to the portions which are not shown in the figure or described in particular in this specification.

Also, the embodiments described in the following are one of the embodiments of the invention individually, and the invention is not limited to these.

### (1) Example of the Configuration of Print Head

First, a brief description will be given of the configuration of a print head. In this embodiment, a description will be given of an embodiment of the print head of an ink-jet method.

The print head which is removable from the main unit (case) of the printer is used. Slots are formed on the print head in order to attach and detach ink cartridges filled with ink. An opening is formed at the bottom of each slot for leading ink to a nozzle. The opening is connected to the corresponding nozzle group through a flow path. Accordingly, ink is supplied to a nozzle group from the cartridge through the opening and the flow path.

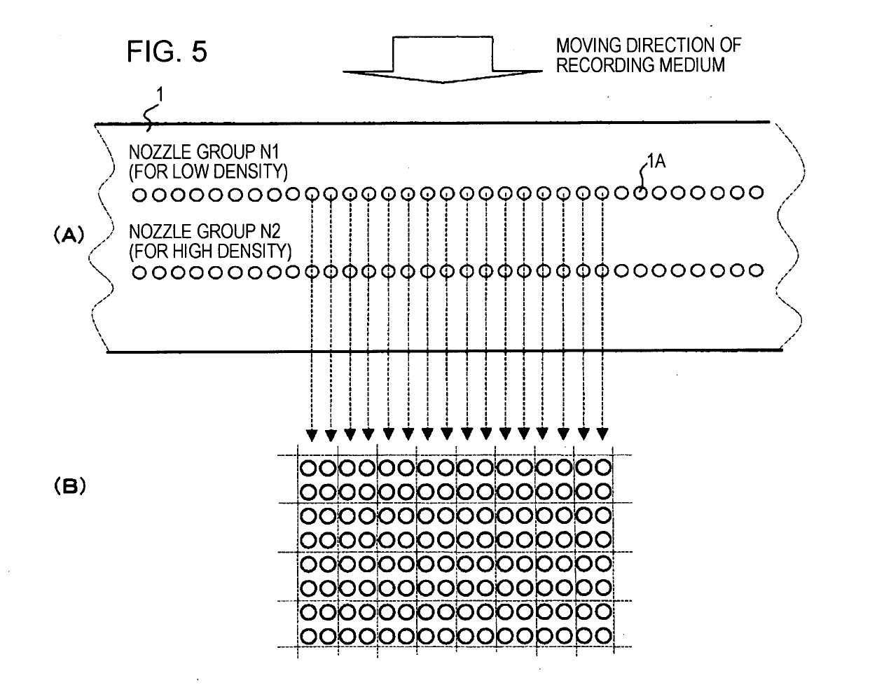

FIG. 5(A) illustrates an example of the nozzle face 1 of the print head used in this embodiment. FIG. 5(A) is the case where the print head has a line-head configuration. Two lines of nozzle groups N1 and N2 are disposed in the moving direction of the recording medium on the nozzle face 1. On each of the nozzle group, a nozzle 1A is formed with a regular pitch (assuming 600 dpi in this embodiment) along the same length as the print width.

In the case of the embodiment, low-density black ink is ejected from the nozzle group N1, and high-density black ink is ejected from the nozzle group N2. In the following, the low-density black ink is called light ink, and the high-density black ink is called dark ink.

FIG. 5(B) illustrates an example of a relationship between a pixel and a nozzle. FIG. 5(B) illustrates the case of forming a pixel by a half of a nozzle pitch, that is to say, 300 dpi. The range surrounded with broken lines corresponds to one pixel. In this case, one pixel is formed by four dots. The four dots are formed by either one of or both of the nozzle groups N1 and N2.

Of course, when one pixel is formed by the same resolution as the nozzle pitch, one pixel is formed by one dot.

### (2) Example of Output Pattern

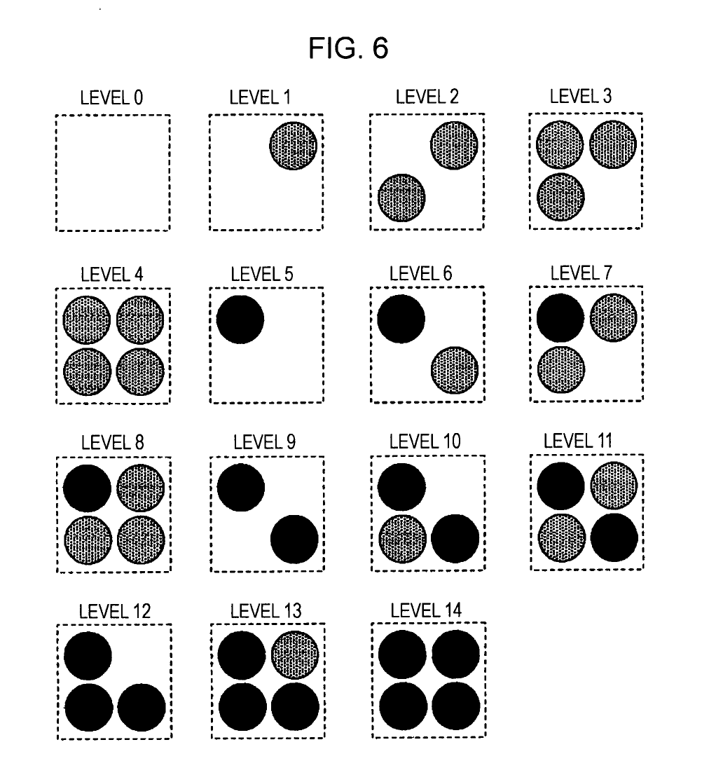

FIG. 6 illustrates an example of output patterns to be used in the present embodiment. FIG. 6 assumes the case where an image having a resolution ½ times a nozzle pitch is formed on a recording medium using the line head (FIG. 5) capable of ejecting two kinds of, light and dark, ink.

In this case, one pixel is represented vertically and laterally by two dots, respectively. That is to say, one pixel is formed as a matrix disposition of four dots.

Either one of the two kinds of, dark and light, ink or no ejection is allocated to each dot. That is to say, one dot is assumed not to be formed with the two kinds of, dark and light, ink simultaneously.

Furthermore, to put it another way, the two kinds of, dark and light, ink exclusively forms each dot using a single piece of ink.

At this time, one pixel can be expressed as 15-gradation output pattern.

The level 0 corresponds to no ejection of ink. Also, the levels 1 to 4 correspond to one to four dots of light ink. Also, the levels 5 to 8 correspond to the combination of one dot of dark ink and three dots of light ink. Also, the levels 9 to 11 correspond to the combination of two dots of dark ink and zero to two dots of light ink. Also, the levels 12 and 13 correspond to the combination of three dots of dark ink and zero dot or one dot of light ink. Also, the level 14 corresponds to four dots of the dark ink.

Here, the level 0 is used for the pixel expressing the lowest density. The density of each pixel increases with increasing the level. The level 14 is used for expressing the highest density. That is to say, the level 0 corresponds to the lightest pixel, and the level 14 corresponds to the darkest pixel.

By such a combination of the dot disposition and the density of the ink, the following advantages are expected.

First, the area ratio of a dot constituting the pixel of the level 1 to that pixel becomes ¼. Thus, it is possible to form an empty space ¾ times one pixel around the dot.

Accordingly, in the gradation expression of the level 1, it is not possible that a dot is connected to another dot adjacently in any case. That is to say, it is possible to dispose a dot dispersedly in a state in which an empty space of three dots or more is always assured.

As a result, the higher the pixel density, the more unique dot density can be achieved. On the contrary, uneven distribution of dots can be eliminated, and thus it is possible to reproduce smooth high-lighted portion having little granularity.

However, if the 15 gradations are directly used for printing, granularity is apt to appear at the time of reproducing a middle density area in relation to an area filling factor.

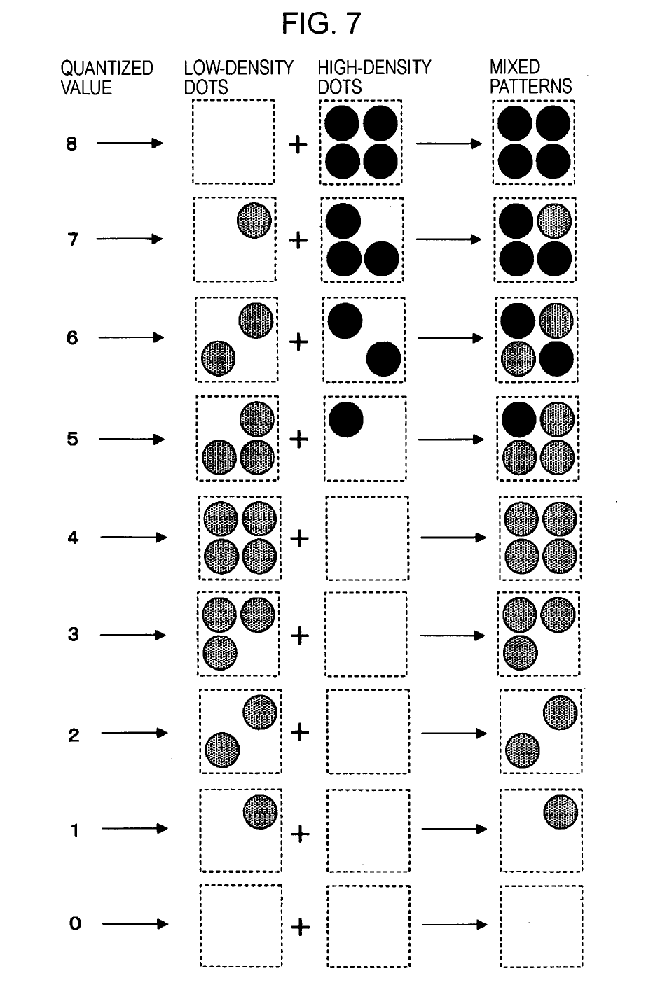

Thus, nine kinds of output patterns shown in FIG. 7 are selectively used. The nine kinds of output patterns shown in FIG. 7 are selected such that a dot having a high density does not exist separately. That is to say, the four dots are selected as much as possible such that a mixed pattern of a high-density dot and a low-density dot is produced.

Specifically, the levels 0 to 4 in FIG. 6 are related to the quantized values “0” to “4”.

Also, the level 8 in FIG. 6 is related to the quantized value “5”. Similarly, the level 11 in FIG. 6 is related to the quantized value “6”, and the level 13 in FIG. 6 is related to the quantized value “7”.

Then, the level 14 in FIG. 6 is related to the quantized value “8”.

That is to say, in these nine kinds of output patterns, a mixed pattern is selected such that the low-density dots are gradually increased to a maximum number of dots, and then with increasing high-density dot, the low-density dots are gradually decreased.

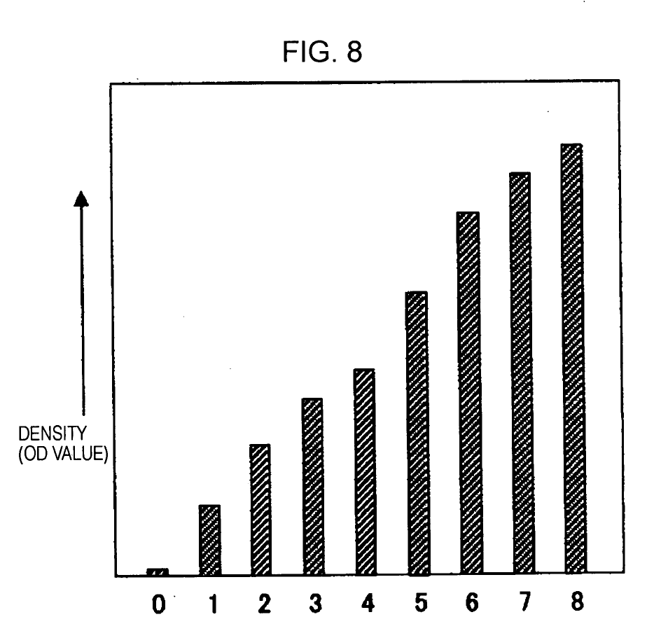

However, if the nine kinds of output patterns shown in FIG. 7 is directly used for printing, its density reproducing characteristic becomes nonlinear as shown in FIG. 8 by the influence of the area filling factor of the dot, etc. That is to say, the distortion occurs in the gradation to be reproduced.

Accordingly, in the case of using the nine kinds of output patterns shown in FIG. 7, it is necessary to correct the density reproducing characteristic.

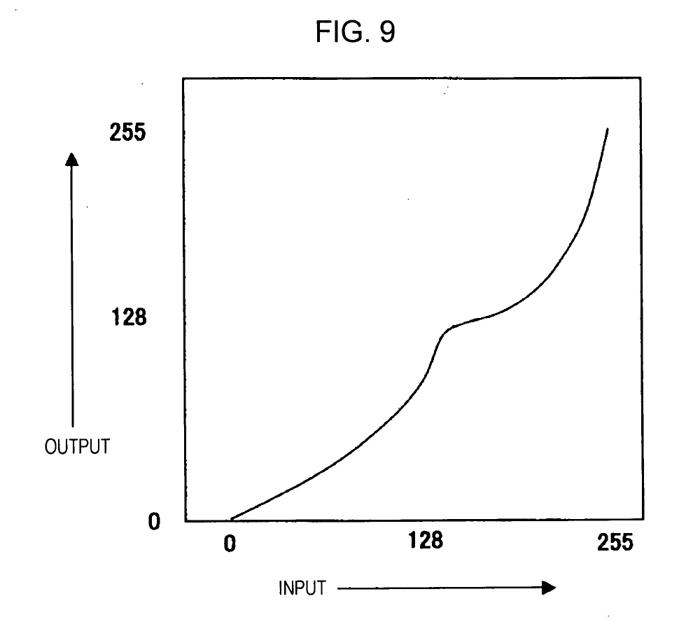

Thus, the output patterns are used in combination with a gamma-correction section having a gamma correction characteristic shown in FIG. 9. That is to say, a gamma-correction section having a reverse characteristic of the density reproducing characteristic shown in FIG. 8 is disposed at the prior stage of an error-diffusion processing (halftoning processing).

In this manner, it becomes possible to use the nine kinds of output patterns (the output patterns whose distribution of dark and light ink is determined in advance) shown in FIG. 7.

In this regard, by reproducing the gradation of each pixel using a mixed pattern of dark and light ink, it becomes hard to generate a step and a pseudo-contour which arise from a subtle difference in the density level and ink color even when a gradation pattern having a density changing continuously from a highlighted portion to a shadow portion is printed. That is to say, it is possible to reproduce densities smoothly from a low-density portion to a high-density portion.

### (3) Embodiment of Printer

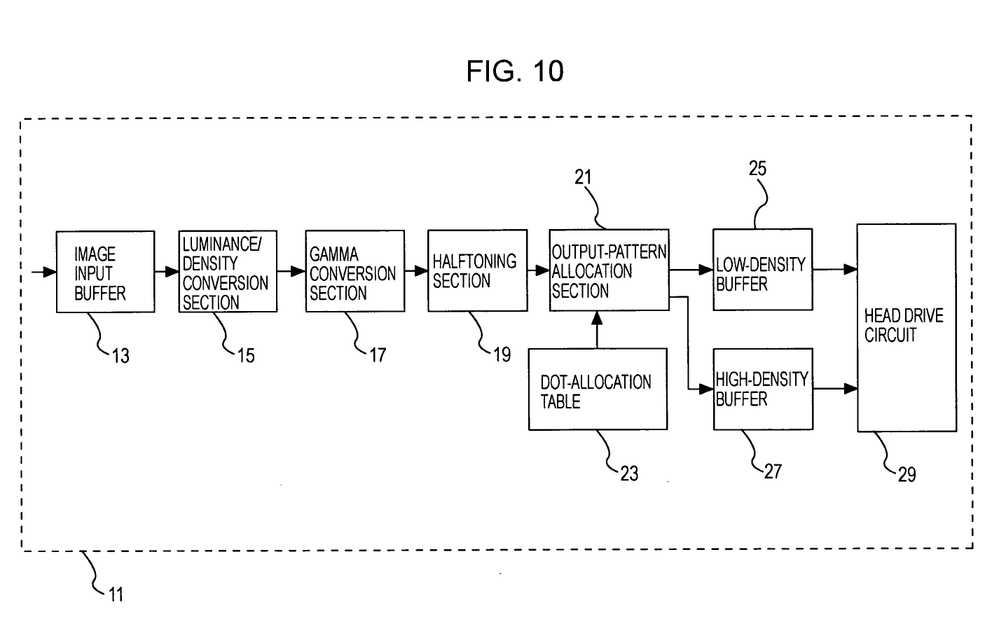

FIG. 10 illustrates an example of the circuit configuration of a printer 11.

In this regard, the printer 11 is assumed to include a print head having the nozzle configuration shown in FIG. 5. That is to say, the printer 11 is assumed to include a print head having a nozzle pitch of 600 dpi. Also, the resolution of the print data is assumed to be given by 300 dpi.

FIG. 10 corresponds to the circuit configuration of the signal processing section operating when print data having a resolution half the maximum resolution of the print head is input.

The printer 11 includes an image input buffer 13, a luminance/density conversion section 15, a gamma conversion section 17, a halftoning section 19, an output-pattern allocation section 21, a dot-allocation table 23, a low-density buffer 25, a high-density buffer 27, and a head drive circuit 29.

In the case of this embodiment, the function of print controller is provided at least by the output-pattern allocation section 21.

Among these, the image input buffer 13 is a storage device for temporarily storing characters, images, and the other print data. For example, a semiconductor memory, or a hard disk is used. In this regard, the print data is given as luminance data corresponding to each pixel.

The luminance/density conversion section 15 is a processing device for converting a luminance value to the density data having 256 stages.

The gamma conversion section 17 is a processing device for correcting density data in accordance with the gamma characteristic shown in FIG. 9. In the case of this example, correction is performed so as to enhance the middle density region.

The halftoning section 19 is a processing device for reducing the number of gradations of the density data after the gamma correction. In this embodiment, the density data of 256 gradations is reduced to nine gradations.

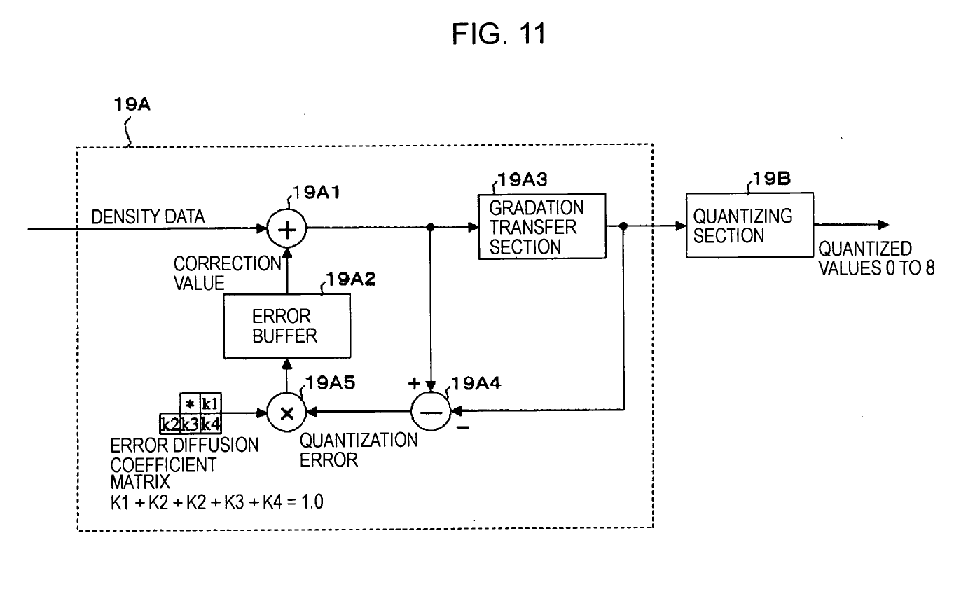

FIG. 11 illustrates an example of the circuit configuration of the halftoning section 19. The halftoning section 19 includes an error-diffusion processing section 19A and a quantizing section 19B.

Here, an adder 19A1 operates as a computing unit for adding a correction value to the density data. The addition processing corresponds to the correction processing for diffusing the quantization error generated before to the surrounding pixels. In this regard, the correction value is given from an error buffer 19A2.

The density data, which has been subjected to the quantization-error correction, is compared with nine kinds of threshold values in a gradation transfer section 19A3.

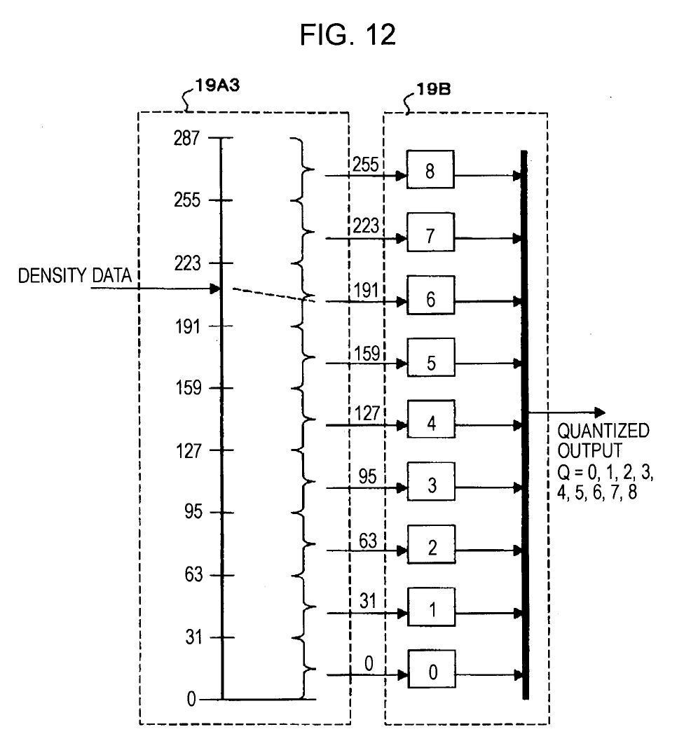

FIG. 12 illustrates the schematic diagram. In the case of FIG. 12, the threshold values are nine kinds, “0”, “31”, “63”, “95”, “27”, “159”, “191”, “223”, and “255”.

The gradation transfer section 19A3 converts the density data into any one of the nine kinds of threshold values. That is to say, the gradation transfer section 19A3 performs gradation transfer (Gradation transfer) processing on the details of the density data.

Part of the density data after the gradation transfer processing is converted into numeric values “0” to “8” in the quantizing section 19B.

Also, part of the density data after the gradation transfer processing is subtracted from the value before the gradation transfer processing in a subtracter 19A4. This subtraction processing corresponds to the calculation processing of the quantization error.

The calculated quantization error is multiplied by an error diffusion coefficient in a multiplier 19A5, and the multiplication result is stored in the error buffer 19A2 as a correction value.

The output-pattern allocation section 21 is a processing device which reads the output pattern data corresponding to the dot information (quantized values), “0” to “8” and relates them. That is to say, the output-pattern allocation section 21 is a processing device which refers to the dot-allocation table 23 and converts the dot information (quantized values) into the output pattern data.

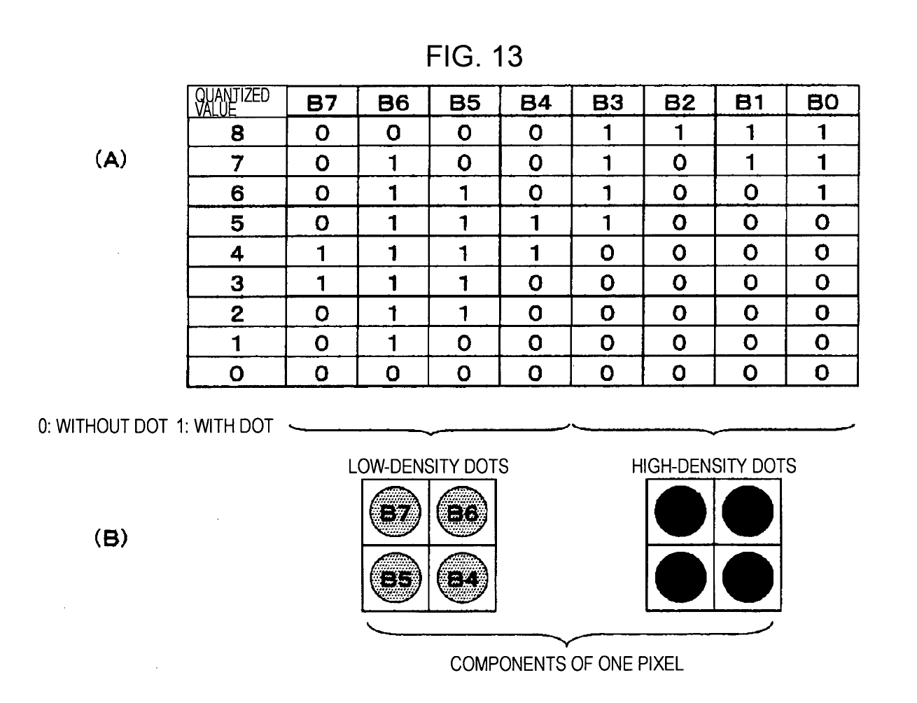

FIG. 13 illustrates the output pattern data to be stored in the dot-allocation table 23. In this regard, this output pattern data corresponds to the nine kinds of output patterns shown in FIG. 7. That is to say, the quantized values “0” to “8” shown in FIG. 13(A) correspond to the quantized values “0” to “18” shown in FIG. 7.

In FIG. 13(A), with or without a dot is expressed by a bit value “0” or “1”. The bit value “0” corresponds to without a bit, and the bit value “1” corresponds to with a bit.

In this regard, as is understood from the comparison with FIG. 13(B), in the case of this example, the upper four bits (B7 to B4) out of the 8-bit output pattern data correspond to the low-density bits, and the lower four bits (B3 to B0) corresponds to the high-density bits.

Both the upper four bits and the lower four bits relate to the four dots corresponding to one pixel.

As described above, the upper bit value and the lower bit value which correspond to the same dot position are selected so as not to have “1” simultaneously.

For example, the bit value “1” is exclusively set at either one of the bit value B7 and the bit value B3, which correspond to the same bit position. Of course, it is allowed for the bit values corresponding to the same bit position to become “0” together.

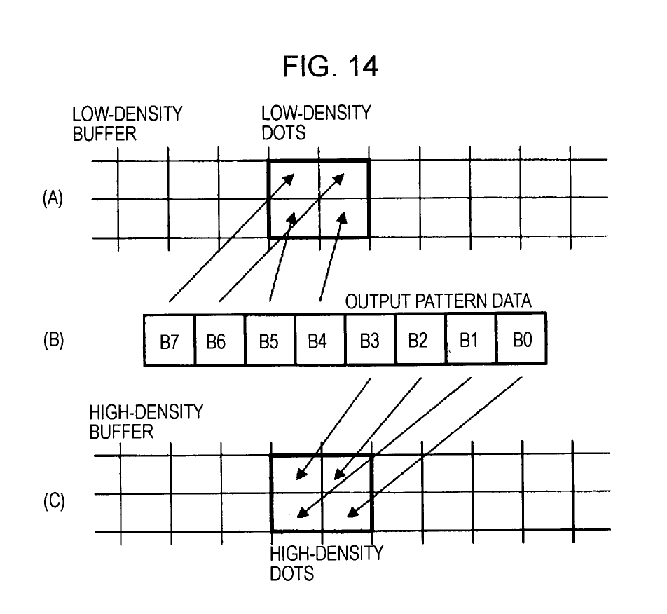

FIG. 14 schematically illustrates the processing operation of the output-pattern allocation section 21. As shown in FIG. 14, the output-pattern allocation section 21 gives the upper four bits to a low-density buffer 25 (FIG. 14(A)) from the output pattern data (FIG. 14(B)) read on the basis of the quantized value corresponding to each pixel, and gives the lower four bits to a high-density buffer 27 (FIG. 14(C)).

The low-density buffer 25 and the high-density buffer 27 are storage devices for temporarily holding the bit data while the bit data is output to the head drive circuit 29 at a predetermined timing.

The head drive circuit 29 is a drive device corresponding to the low-density nozzle group N1 and the high-density nozzle group N2, and executes the operation of ejecting ink droplets from the nozzle of the corresponding position in accordance with the bit data.

### (1) Print Result

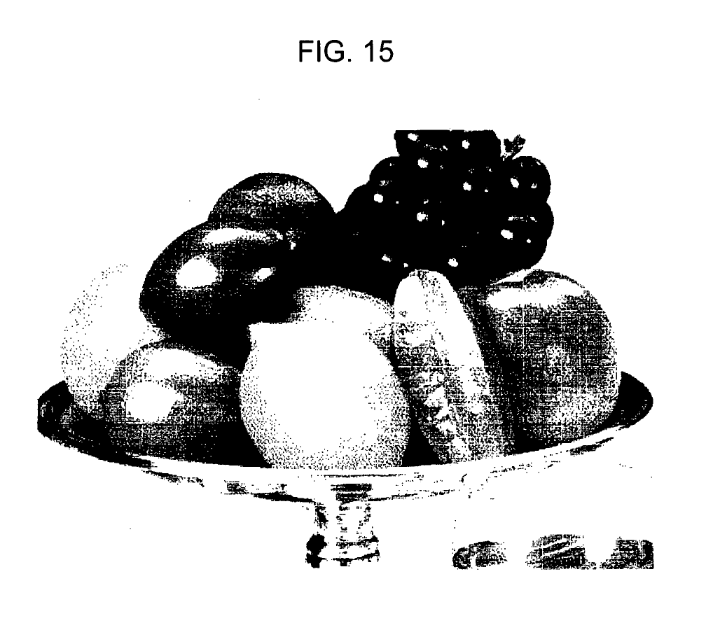

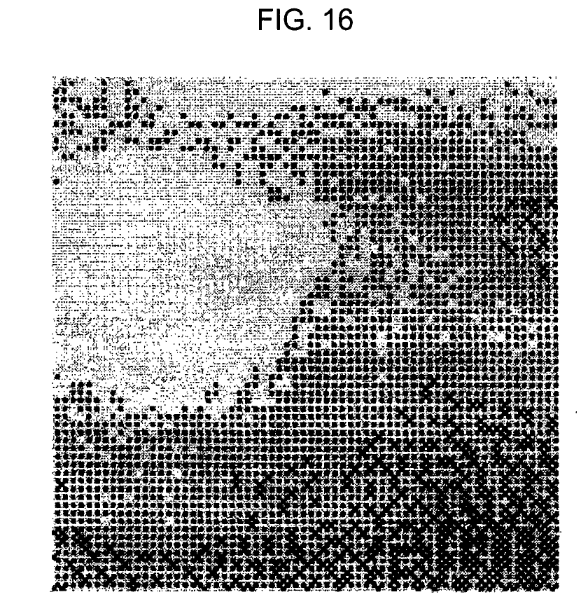

FIGS. 15 and 16 illustrate examples of print to which the method of processing according to the embodiment is applied. That is to say, FIGS. 15 and 16 illustrate examples of print when the print data having a resolution half the nozzle pitch is printed by the method of print according to the embodiment using a print head having two lines of nozzle arrays corresponding to two kinds of ink having different densities.

In the case of FIG. 15, the resolution of each pixel is 300 dpi. However, nine stages of gradations are expressed by dark and light patterns using four dots.

That is to say, FIG. 15 shows the case in which nine-valued error-diffusion processing is applied to the print data. In this regard, FIG. 16 is an enlarged view of a partial area of the print result shown in FIG. 15.

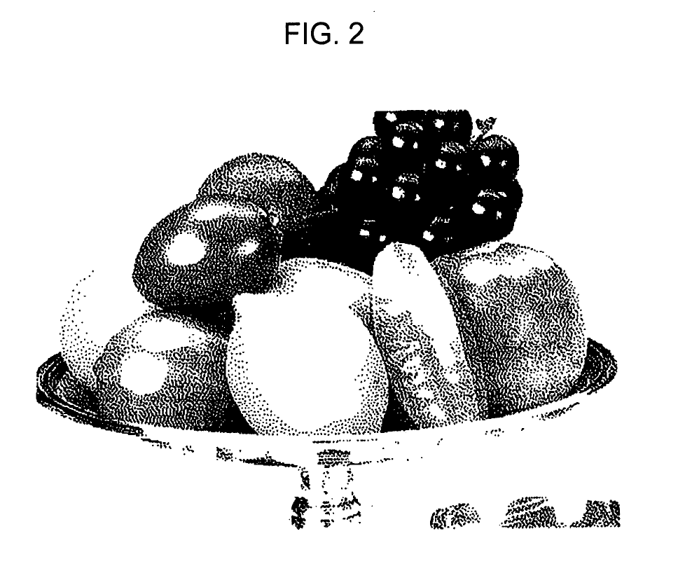

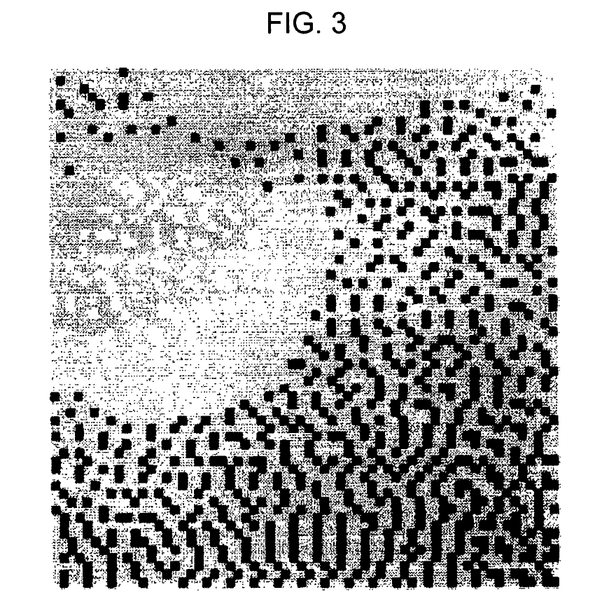

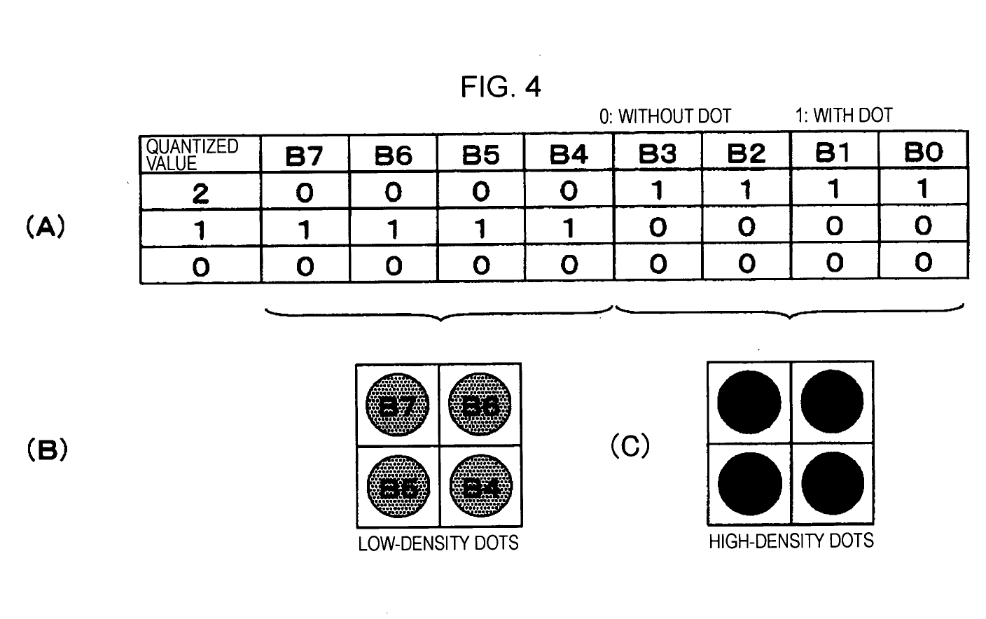

FIGS. 15 and 16 correspond to FIGS. 2 and 3, to which a known technique is applied, respectively. As is understood from the comparison between FIG. 15 and FIG. 2, in the case of the processing method of the embodiment, the granularity of the print result has been improved. Of course, the pseudo-contour is also improved.

This difference in the expressive power is obvious at a glance when FIG. 16 and FIG. 3, which are enlarged views, are compared.

### (5) Advantages in Circuit Configuration

In the case of the printer 11 shown in FIG. 10, high-density bits and low-density bits constituting one pixel can be obtained only by the distribution processing of the output-pattern data corresponding to each pixel. That is to say, it is possible to share the image processing systems for high-density and low-density as far as obtaining the output-pattern data corresponding to each pixel.

This means that it is not necessary to dispose an image processing system for each density. Accordingly, the image processing system can be achieved by the same basic configuration as that of the case of processing a single density.

Thus, the development load of the circuit configuration is reduced. Also, the circuit size is reduced and the advantages of the cost reduction can be expected.

Also, the print data having a low resolution is to be processed, and thus the data size should be small compared with the print data having a high resolution. In addition, the amount of signal processing necessary for signal processing of the print data having a low resolution should be the same as the case of handling a single density ink, and thus the advantage in shortening the processing time can be expected.

Of course, as described above, it is possible to achieve a high gradation expression for the print data having a low resolution. Accordingly, when a printer according to the embodiment is used, it is possible to print high-quality images without granularity and pseudo-contour at the same time while shortening the printing time.

### (6) Another Embodiment

(a) In the above-described embodiment, black ink having different densities is to be ejected. However, the ink to be ejected may be color ink (magenta-series ink, cyan-series ink, and yellow-series ink).

(b) In the above-described embodiment, a description has been given of the case of two kinds of ink having different densities. However, the present invention can be applied to the case of k kinds or more (k is a natural number of 3 or more) of ink having different densities.

In this case, a print head having k lines of nozzle arrays or more should be disposed.

In this regard, it is possible to increase the number of expressible gradations by increasing the number of ink having different densities, and thus allowing to achieve more smooth gradation expression.

Also, it is possible to bring the density reproduction characteristic closer to a line by constituting one pixel by k kinds of ink droplets having different densities. As far as the reproduction characteristic is practically allowed, it is possible to make the gamma-correction processing unnecessary.

(c) In the above-described embodiment, a description has been given of the case of forming one pixel by four dots (two dots×two dots). However, the present invention can also be applied to the case of forming one pixel by nine (three dots×three dots) dots or more, that is to say, the case of forming one pixel by n to the second power dots (n dots×n dots).

It is possible to increase the number of expressible gradations with increasing the number of dots constituting one pixel, and thus allowing to achieve a more smooth gradation expression. In this case, the data size of the print data becomes further smaller, and thus allowing to further shorten the printing time.

In this case, as far as the density reproduction characteristic is practically allowed, it is also possible to make the gamma-correction processing unnecessary.

(d) In the above-described embodiment, a description has been given of the case of forming one dot by one shot of ink droplet. However, one dot may be formed by a plurality of shots of ink droplet.

It is possible to further increase the gradation expression power by means of varying a dot diameter or varying a density by constituting one dot with a plurality of shots of dot.

(e) In the above-described embodiment, a description has been given of the case where all the dot diameters are the same. However, the dot diameter may be variable by the adjustment of the amount of ink droplet.

Also, the dot diameter may be variable in accordance with ink density. It is possible to further increase the gradation expression power by varying the dot diameter.

(f) In the above-described embodiment, a description has been given of the configuration of the signal-processing section which processes print data having a resolution half the resolution of a print head. However, it is desirable to include a signal processing section (resolution-determination section) for determining the resolution of print data.

That is to say, it is desirable to include a resolution-determination section which determines the resolution of print data on the basis of the resolution information attached to the print data, and instructs to change the signal processing to be applied.

In this regard, when print data having a resolution of 600 dpi, which is the same as the maximum resolution of the print head, is input, a known processing technique should be used for that signal processing. For example, each dot should be expressed by three gradations.

Of course, in the case of print data having a high resolution, the pixel size is minimized, and thus it is possible to obtain a print result having high print quality.

On the other hand, since print data having a high resolution has a large data size, the communication time and processing time become long.

(g) In the above-described embodiment, a description has been given of the case where when print data having a resolution half the maximum resolution of the print head is input, signal processing to increase the gradation expression is applied. However, the kind of signal processing to be applied may be selected on the basis of the additional information of the print data.

For example, when the user wants a draft print, the additional information of the print data may include an instruction for applying a known print technique. In this case, an additional-information determination section for interpreting the content of such additional information is included in the printer.

When the additional-information determination section determines the application of a know print technique, three-valued error-diffusion processing is applied to the print data having a resolution of 300 dpi.

Next, a description will be given of a second embodiment of a print method to which a technique according to the present invention is applied.

In this regard, in the second embodiment, to the portions not particularly shown in the figure or described, a known or publicly known technique in that technical field is applied.

Also, the embodiment described in the following is an embodiment of the present invention, and the present invention is not limited to these.

In the first embodiment, a description has been given of the case where one dot is formed by one shot of ink droplet. However, in the second embodiment, one dot is formed by a plurality of shots of ink droplet.

### (A) Example of Configuration of Print Head

The print head to be used in the second embodiment has the same configuration as that of the print head used in the first embodiment. However, the print head is different in that it forms one dot by a plurality of shots of ink droplet.

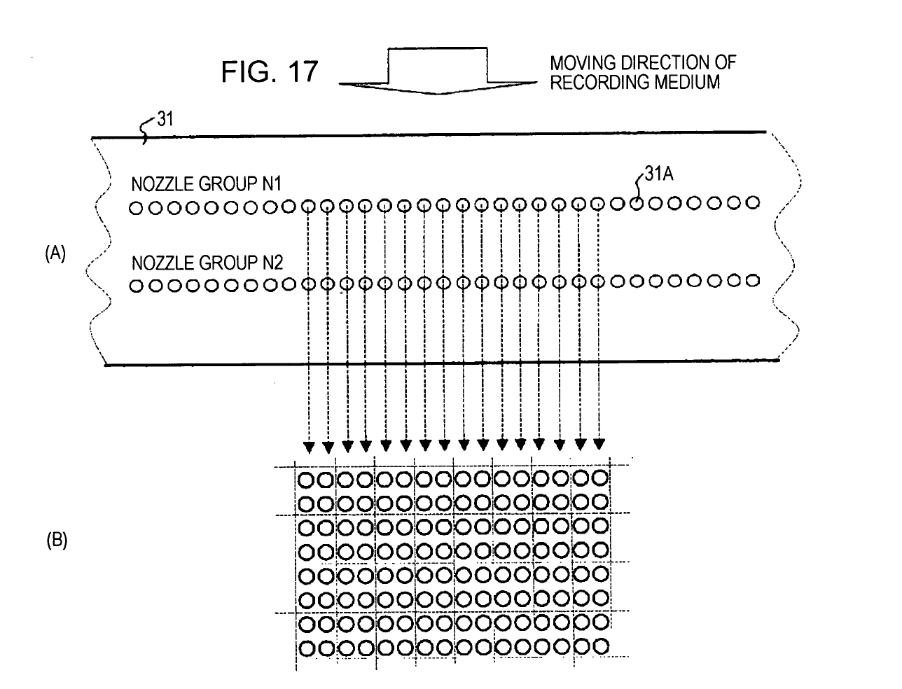

FIG. 17(A) illustrates an example of a nozzle face 31. FIG. 17(A) is the case where the print head has a line head configuration. The print head of the second embodiment has the same configuration as that of the first embodiment.

That is to say, two lines of the nozzle groups N1 and N2 are disposed in the moving direction of the recording medium on the nozzle face 31. Nozzles 31A are formed in each of the nozzle groups with a predetermined pitch (for example, 600 dpi) along the same length as the print width.

In the second embodiment, light ink is ejected from the nozzle group N1, and dark ink is ejected from the nozzle group N2 in the same manner as the first embodiment.

FIG. 17(B) illustrates an example of a relationship between pixels and nozzles. FIG. 17(B) illustrates the case of forming a pixel with a half of the nozzle pitch, that is to say, 300 dpi.

The range surrounded with broken lines corresponds to one pixel. In this case, one pixel is formed by four dots (a dot group of two rows×two column). The four dots are formed by either one of or both of the nozzle groups N1 and N2.

Of course, when one pixel is formed by the same resolution as the nozzle pitch, one pixel is formed by one dot.

In this regard, in the second embodiment, each dot is formed by a maximum of six shots of ink droplet. A dark dot can be formed in direct proportion to the number of ink droplets. In this embodiment, each dot can be expressed by the density in seven gradations including no ejection.

### (B) Example of Dot Pattern

Here, the examples of the dot patterns that can be expressed using the above-described printing conditions are shown.

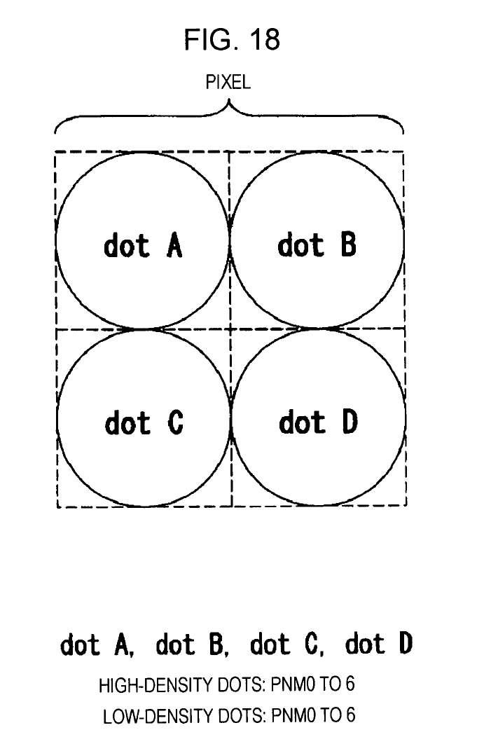

FIG. 18 is illustrates an example of a dot array forming each pixel. Here, each dot is called as follows.

That is to say, a dot positioned at the upper left corner is called “dot A”. A dot positioned at the upper right corner is called “dot B”. A dot positioned at the lower left corner is called “dot C”. A dot positioned at the lower right corner is called “dot D”.

As described above, 0 to 6 shots of dark ink or light ink can be ejected in piles on each dot. Thus, one pixel can be formed as a set of ink droplets from 0 (zero) to a maximum of 24 shots.

In the following, examples of typical dot patterns are shown.

### (a) TYPE1

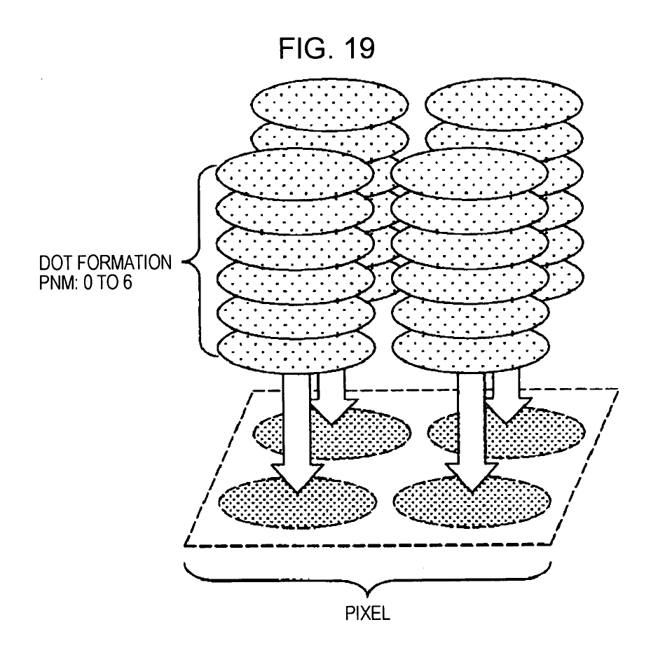

FIG. 19 is an example of the dot pattern when all the four dots are formed by light ink.

In this case, the number of droplets of light ink can be selected in the range of 0 to 24 droplets. Accordingly, it becomes possible to express density in 25 ways for the entire pixel.

(b) TYPE2

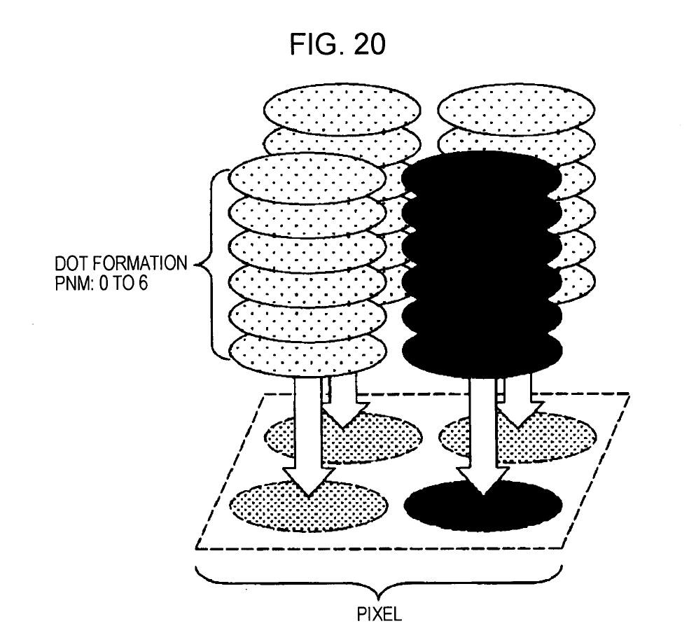

FIG. 20 is an example of the dot pattern when three dots are formed by light ink and one is formed by dark ink.

In this case, the number of light ink droplets can be selected in the range of 0 to 18 droplets. Also, the number of dark ink droplets can be selected in the range of 0 to 6 droplets. Accordingly, it becomes possible for the entire pixel to express density in 36 ways.

In this regard, the position of the dot formed by dark ink may be any one of the dot A, B, C, or D. That is to say, three other dispositions can be considered in addition to FIG. 20. Although even the position of the dot formed by dark ink is changed, the density reproduced as the entire pixel is the same.

### (c) TYPE3

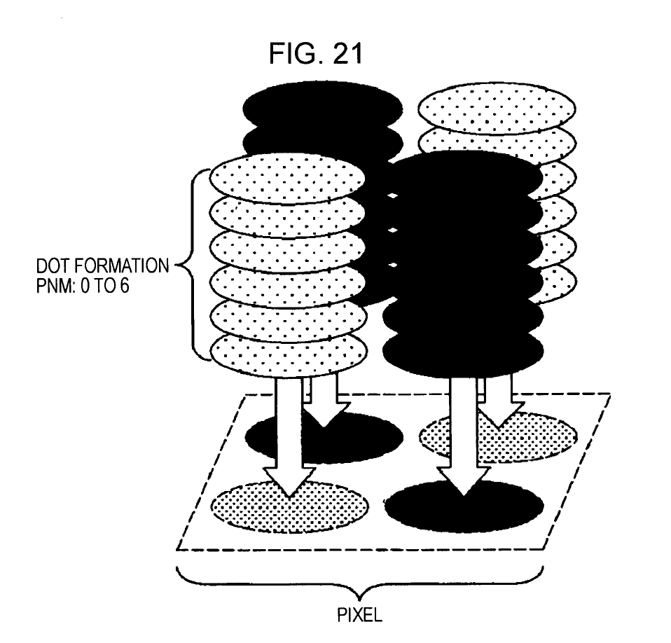

FIG. 21 is an example of the dot pattern when two dots are formed by light ink and the remaining two dots are formed by dark ink.

In this case, the number of light ink droplets can be selected in the range of 0 to 12 droplets. Also, the number of dark ink droplets can be selected in the range of 0 to 12 droplets. Accordingly, it becomes possible for the entire pixel to express density in 72 ways.

In this case, the two dot positions formed by light ink may be any two of the dots A, B, C, and D. That is to say, five other dispositions can be considered in addition to FIG. 21. The dot dispositions do not influence the density expression in the same manner as described above.

### (d) TYPE4

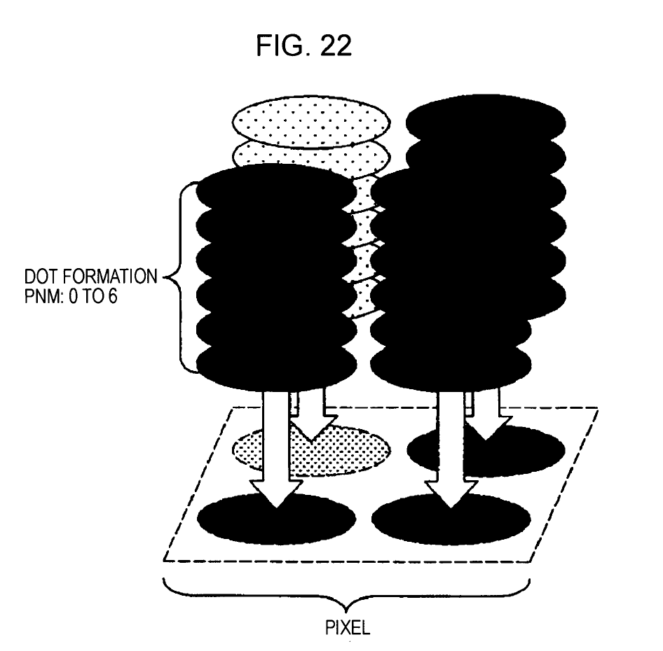

FIG. 22 is an example of the dot pattern when one dot is formed by light ink and the remaining three dots are formed by dark ink.

In this case, the number of light ink droplets can be selected in the range of 0 to 6 droplets. Also, the number of dark ink droplets can be selected in the range of 0 to 18 droplets. Accordingly, it becomes possible for the entire pixel to express density in 36 ways.

In this case, the one dot position formed by light ink may be any two of the dots A, B, C, and D. That is to say, three other dispositions can be considered in addition to FIG. 22. The dot dispositions do not influence the density expression in the same manner as described above.

### (e) TYPE5

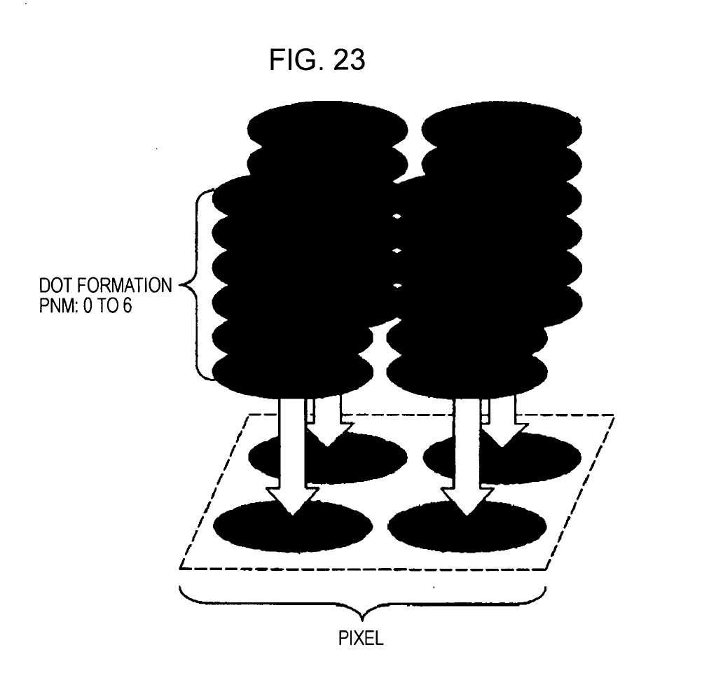

FIG. 23 is an example of the dot pattern when all the four dots are formed by dark ink.

In this case, the number of dark ink droplets can be selected in the range of 0 to 24 droplets. Accordingly, it becomes possible for the entire pixel to express density in 25 ways. However, the case where the number of droplets is (zero) is included in TYPE1. After all, in this case, the density expressions in 24 ways are possible.

### (f) Summary

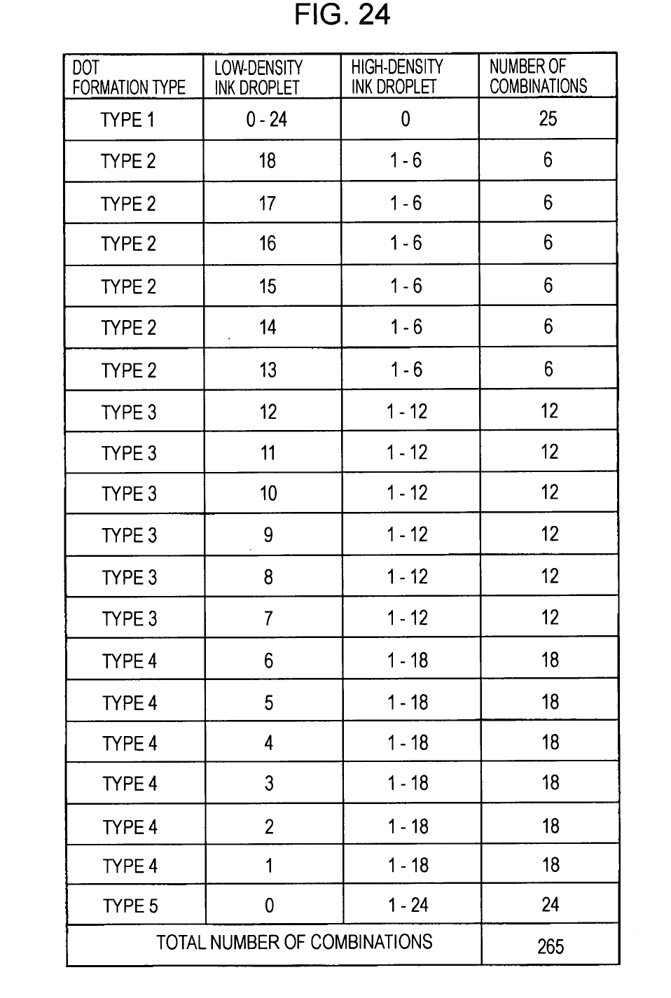

FIG. 24 shows the number of density expressions that can be obtained by TYPES 1 to 5 described above in a tabular form.

As shown in FIG. 24, it is possible to express one pixel by densities of 256 gradations by adopting these five kinds of dot patterns.

This exceeds the 256 gradations, which are the gradations of a general monochrome image handled by a computer.

Accordingly, if these dot patterns are related to 256 gradations of density data with a one-to-one relationship, it is possible to eliminate dither processing and halftoning processing.

In this regard, in order to relate dot patterns to 256 gradations, it is necessary to measure the specific density to each dot pattern.

Thus, a certain area is printed by each dot pattern, and the specific density to each dot pattern is measured.

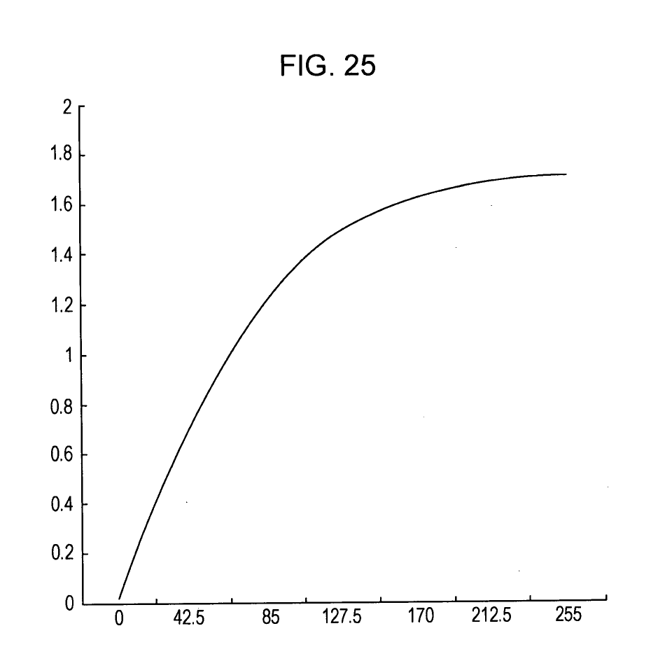

When this measurement result is sorted and plotted in sequence from low-density data to high-density data, a curve roughly shown in FIG. 25 is obtained.

In this regard, in FIG. 25, in order for the curve to change as smoothly as possible, nine gradations are removed from the 256 gradations, and the numbers 0 to 255 are allocated to the remaining 256 gradations. The lateral axis corresponds to a serial number assigned to the dot patterns in ascending order. The vertical axis is a measured density.

As a result of the sorting of the dot patterns, a one-to-one relationship between the density data, which is image information, and the number of dot patterns is achieved.

However, the density reproducing characteristic by the 256 gradations has approximately the same curved characteristic as the former density reproducing characteristic.

Accordingly, if the density data are directly related to the corresponding dot patterns, distortion arises in the gradations of the reproduced density.

Thus, a method is adopted in which the density data is converted by a reverse characteristic curve negating the density reproducing characteristic held by the dot pattern before relating the density data to the dot patterns.

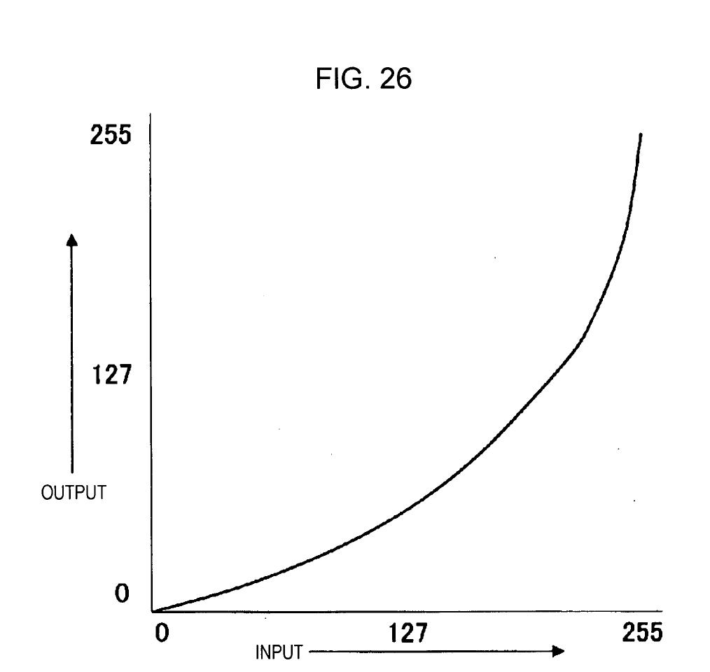

This method is called gamma correction. FIG. 26 shows an example of a gamma-correction curve. Dot-pattern numbers are related to the density data which has been corrected by this gamma-correction curve, and the distortion of the gradations reproduced as a print result can be cancelled.

In this regard, the larger the number of dots forming a pixel, and the larger the number of kinds of ink, the larger the number of pixels can be thinned. Thus, it is possible to bring the density reproducing curve closer to a line.

### (C) Example of Configuration of Printer (Print Controller)

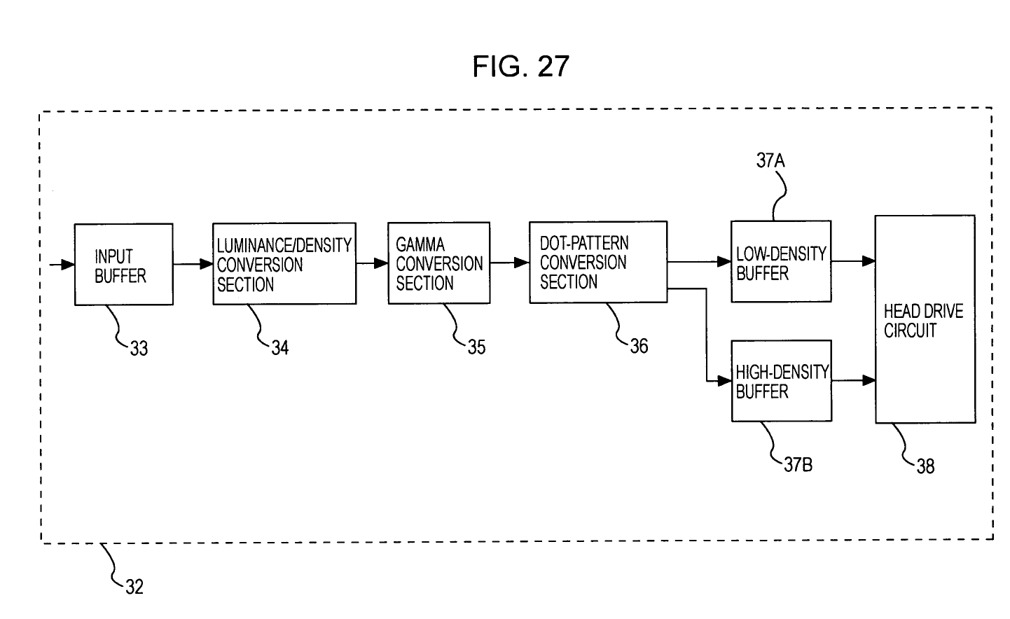

FIG. 27 illustrates an example of the circuit configuration of a printer 32. In this regard, the printer 32 is assumed to include a print head having the nozzle configuration shown in FIG. 17. That is to say, it is assumed that a line head having a nozzle pitch of 600 dpi is attached to the printer 32.

Also, the printer 32 also includes a signal processing system for color printing. However, FIG. 27 illustrates only the signal processing system for monochrome printing.

The printer 32 includes an input buffer 33, a luminance/density conversion section 34, a gamma conversion section 35, a dot-pattern conversion section 36, a low-density buffer 37A, a high-density buffer 37B, and a head drive circuit 38 as major components.

Among these, the input buffer 33 is a storage device for temporarily storing characters, images, and the other print data. For example, a semiconductor memory or a hard disk drive is used. In this regard, FIG. 27 is the case of monochrome printing, and thus the print data is given as luminance data.

The luminance/density conversion section 34 is a processing device for converting luminance data into the density data 0 to 255.

The gamma conversion section 35 is a processing device which cancels the distortion due to the density reproducing characteristic (FIG. 25) held by the dot pattern, and performs gamma correction on the input density data. The input/output characteristic shown in FIG. 26 is used for the correction. In this regard, the density data after the gamma correction is directly output to the dot-pattern conversion section 36.

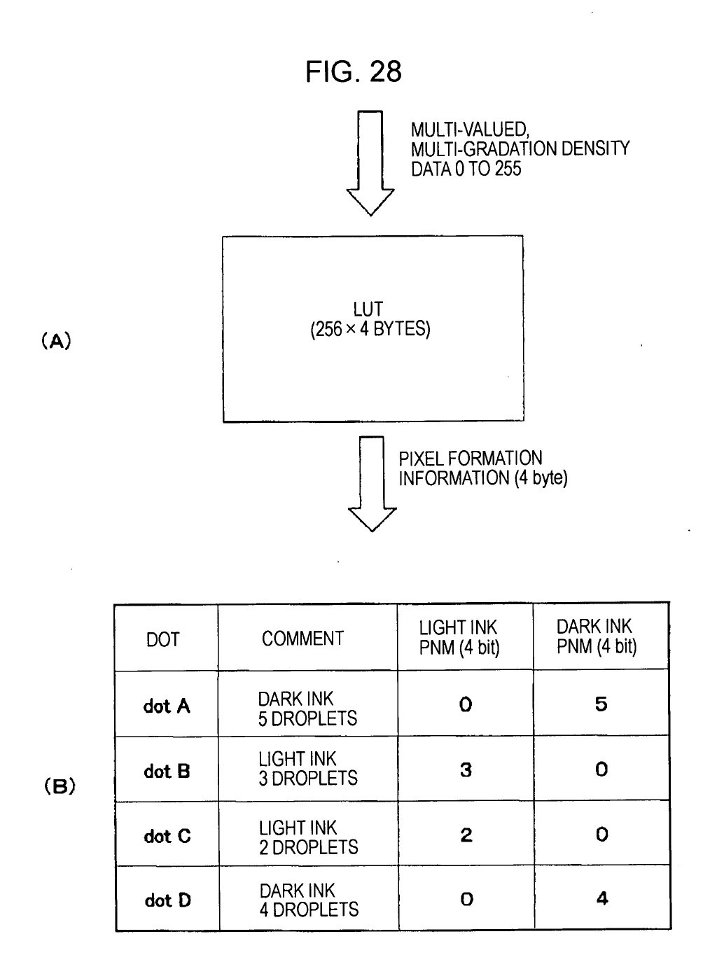

The dot-pattern conversion section 36 is a look-up table which stores density data and the dot-patterns with a one-to-one relationship. In the case of this embodiment, the storage capacity is given by 256 gradations×4×8 (bits) (1 Kbytes) as shown in FIG. 28(A).

Here, “4” in the former expression corresponds to four dots A to D. Also, “8” in the former expression corresponds to the number of ink droplets of the dark and light ink corresponding to the dots A to D.

As shown in FIG. 28(B), the four bits out of the eight bits are for light ink, and the remaining four bits are for dark ink.

The dot-pattern conversion section 36 uses the input density data as a read address, and outputs the dot pattern corresponding to the read address.

The dot pattern includes a pair of nozzle drive data representing how many droplets of the light ink and the dark ink are output on each dot position, respectively.

In this regard, ejecting the light ink and the dark ink onto the same dot is prohibited.

Accordingly, the number of ink droplets of the dark ink corresponding to the dot position on which the light ink is ejected is set to 0 (zero). For example, in the case of FIG. 28(B), the nozzle drive data for the light ink of the dot B is 3, and the nozzle drive data for the dark ink is 0 (zero).

Of course, the number of ink droplets of the light ink corresponding to the dot position on which the dark ink is ejected is set to 0 (zero). For example, in the case of FIG. 28(B), the nozzle drive data for the light ink of the dot D is 0 (zero), and the nozzle drive data for the dark ink is 4.

Here, the nozzle drive data for each ink is output to the corresponding output buffer. In the case of this embodiment, the data is output to the low-density buffer 37A and the high-density buffer 37B.

At this time, the low-density buffer 37A and the high-density buffer 37B store the nozzle drive data in the four (two rows×two columns) addresses corresponding to each pixel, and holds until the print timing.

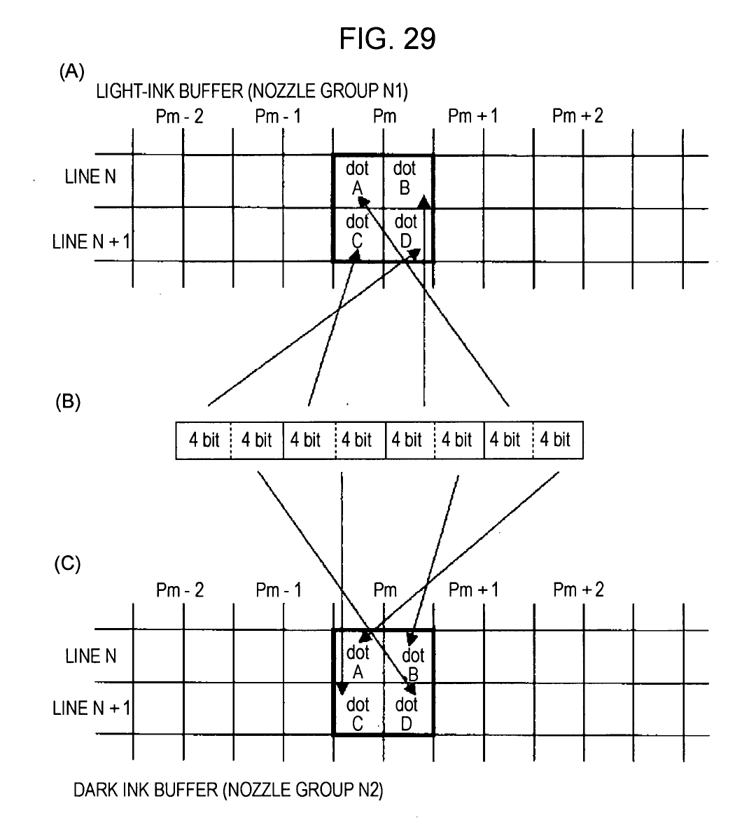

FIG. 29 schematically illustrates a method of distributedly reading nozzle drive data.

Here, FIG. 29(B) is the nozzle drive data for giving the dot pattern corresponding to the density data of a certain pixel. As described above, the data includes four bytes. The upper four bits of each byte is for light ink, and the lower four bits are for dark ink.

Each byte of the dot pattern corresponds to the dot A, the dot B, the dot C, and the dot D from the right side in the figure. FIG. 29(A) shows the writing of nozzle drive data into the low-density buffer 37A, and FIG. 29(C) shows the writing of nozzle drive data into the high-density buffer 37B.

The head drive circuit 38 is a drive device for controlling the ejection operation of ink droplets by the low-density nozzle group N1 and the high-density nozzle group N2, and ejects the number of ink droplets specified by the nozzle drive data.

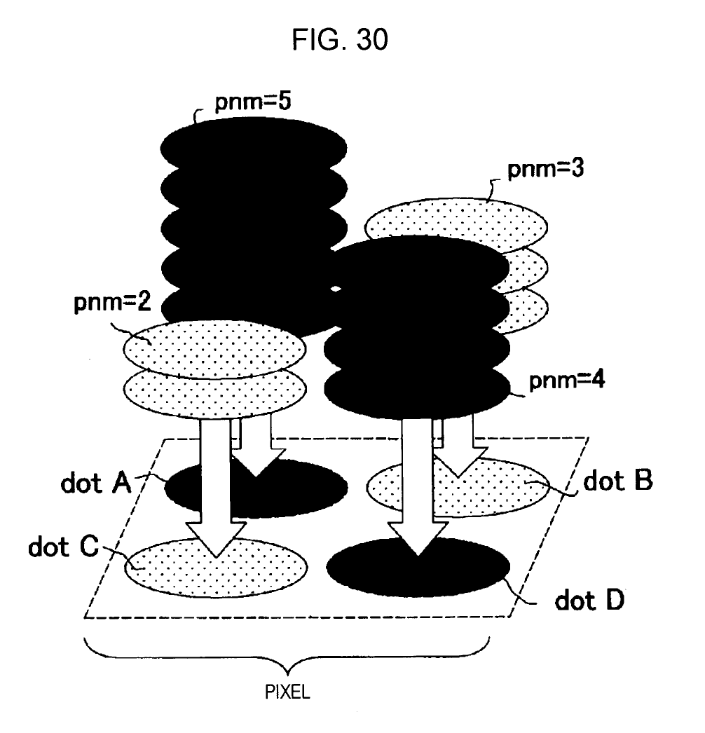

FIG. 30 illustrates a print result of a certain pixel. This print result corresponds to the dot pattern shown in FIG. 28(B).

As shown in FIG. 30, the dot A is formed by five droplets of the dark ink, the dot B is formed by three droplets of the light ink, the dot C is formed by two droplets of the light ink, and the dot D is formed by four droplets of the dark ink.

This print operation is executed for all the pixels constituting an image.

### (D) Advantages of Embodiment

As described above, it is possible to reproduce the density of one pixel with 256 gradations only by means of ink droplets by forming one pixel with a plurality of dots, and at the same time, by forming each dot by ejecting ink droplets in piles using one of a plurality of kinds of ink.

As a result, it is possible to eliminate dither processing and halftoning processing, and thus it is possible to greatly reduce the signal processing load.

Also, it becomes possible to faithfully reproduce the gradation information held by the print image. That is to say, it is possible to further increase the print quality.

### (E) Other Embodiments

(a) In the case of the above-described embodiment, a description has been given of the case where the gradation information held by the gradation data matches the density data of 256 gradations. However, the gradation information held by the gradation data may be 256 gradations or more. In this case, the luminance/density conversion section 34 should reduce the amount of information to 256 gradations.

(b) In the case of the above-described embodiment, a description has been given of the case where the dot-pattern conversion section 36 stores the dot patterns with 256 gradations. However, the dot patterns to be provided may be fewer than that. For example, the dot patterns may be for 230 gradations.

In this case, a signal processing device for reducing the density data to 230 gradations should be disposed at the prior position to the dot-pattern conversion section 36. For example, the signal processing device should be disposed at the prior stage of the gamma conversion section and the luminance/density conversion section.

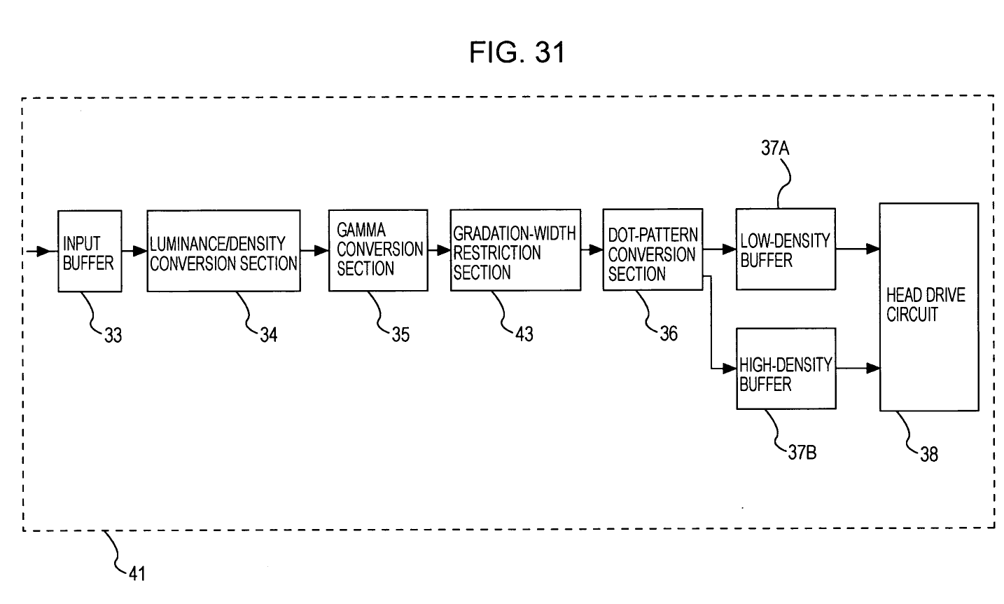

FIG. 31 illustrates an example of the circuit configuration of the printer 41 in which a gradation-width restriction section 43 is disposed between the gamma conversion section 35 and the dot-pattern conversion section 36. In this regard, in FIG. 31, the corresponding portions in FIG. 27 are marked with the same reference numerals and letters.

The gradation-width restriction section 43 is a processing device which generates the density data with 230 gradations from the density data corresponding to 256 gradations. In this regard, the number of gradations is given as the gradation data attached to the image data.

In this case, the gradation-width restriction section 43 discards, for example the density data for the upper 26 gradations. As a result, it is possible to match the input gradation width to the dot-pattern conversion section 36 with the gradation width of the stored dot patterns.

In this regard, it is allowed to adopt a method in which a deficient gradation width is distributed among the gradations, and the density data corresponding to the deficient gradations is related to other gradation values adjacent to either the upper or the lower side.

Also, for example, a method of deleting the upper and lower density data, and a method of deleting the density data for the lower 26 gradations may be adopted.

These methods should be selected in accordance with the amount of data to be deleted or the kinds of images.

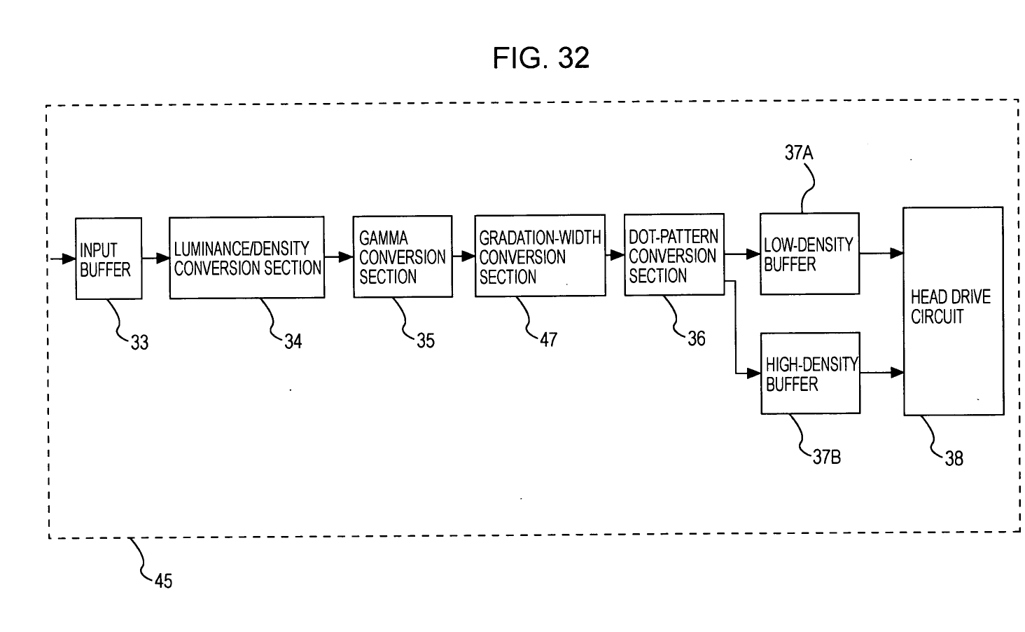

In this regard, the reduction of the gradations of the density data can also be carried out by the following method. FIG. 32 illustrates an example of the circuit configuration of the printer 45 in which a gradation-width conversion section 47 is disposed between the gamma conversion section 35 and the dot-pattern conversion section 36. In this regard, in FIG. 32, the corresponding portions in FIG. 27 are marked with the same reference numerals and letters.

The gradation-width conversion section 47 is a processing device which generates the density data with 230 gradations from the density data corresponding to 256 gradations. In this regard, the number of gradations is given as the gradation data attached to the image data.

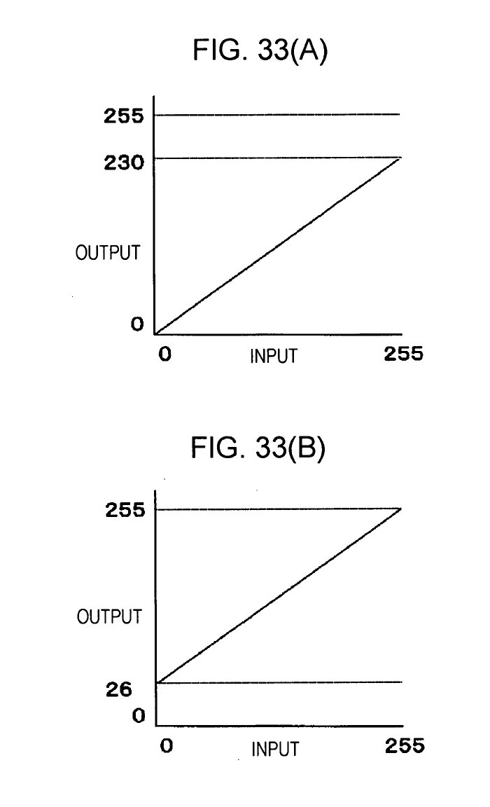

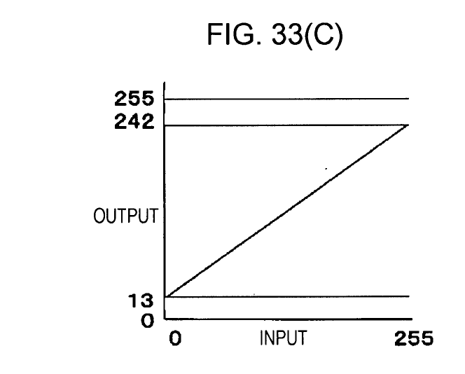

In this case, the gradation-width conversion section 47 should have the input/output characteristic as shown in FIGS. 33(A) to 33(C).

FIG. 33(A) is an example of converting so as to compress the maximum gradation value. FIG. 33(B) is an example of compressing so as to round up the minimum gradation value. FIG. 33(C) is an example of compressing the maximum gradation value and the minimum gradation value into the middle.

These methods should be selected in accordance with the amount of data to be deleted or the kinds of images.

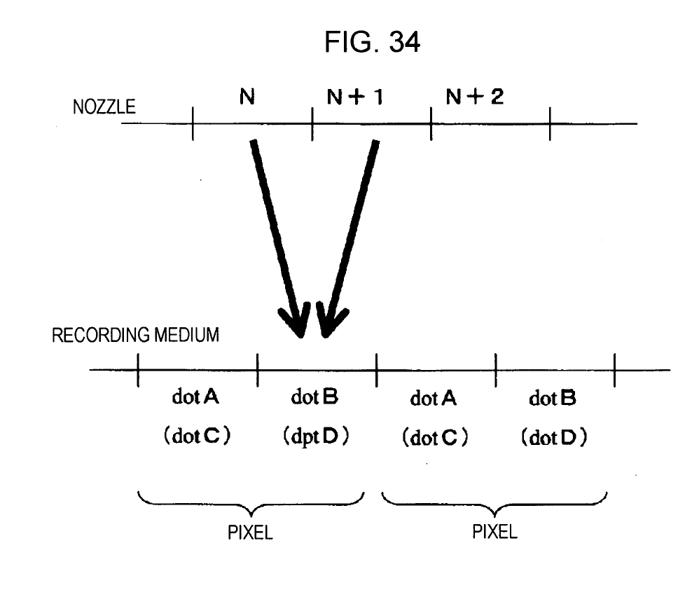

(c) In the above-described embodiment, a description has been given of the case where one dot is formed by one nozzle to which the ejection of ink droplets is assigned. However, as shown in FIG. 34, one dot may be formed by ink droplets in piles by the deflection ejection from a plurality of adjacent nozzles in the same nozzle group.

In this regard, the deflection direction of ink droplets can be adjusted by the amount of heating by a pair of right-and-left heaters formed at the bottom of the nozzle chamber and the timing control. Here, the pair of heaters are disposed in the direction of arranging nozzles.

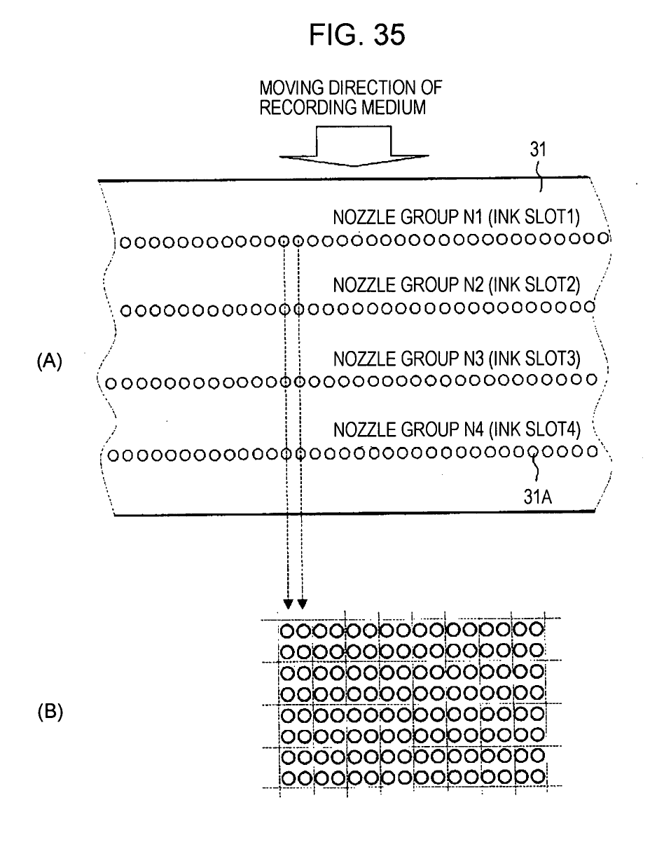

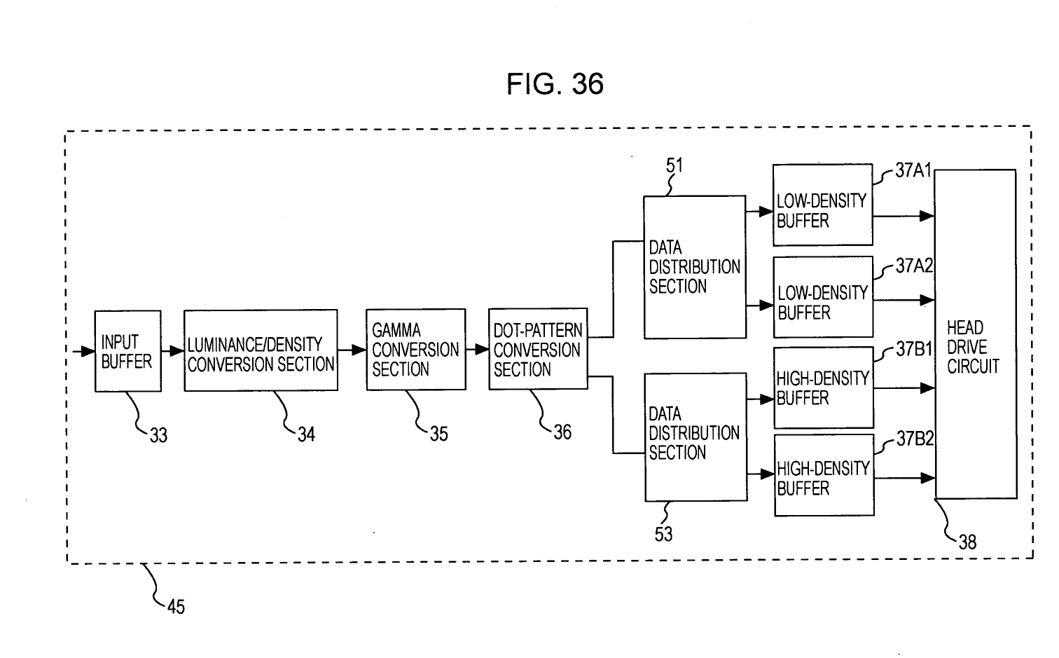

(d) In the above-described embodiment, a description has been given of the case where each one line of dark and light nozzle groups N1 and N2 are disposed. However, as shown in FIG. 35, the present invention can be applied to the case where two lines of dark and light nozzle groups N1 to N4 are disposed. In FIG. 35, the nozzle groups N1 and N2 are for light ink and the nozzle groups N3 and N4 are for dark ink. In FIG. 36, the corresponding portions in FIG. 27 are also marked with the same reference numerals and letters.

In this case, as shown in FIG. 36, it is desirable for the printer 49 to include a mechanism for evenly distributing nozzle drive data in dark and light ink to the corresponding two lines of nozzle groups.

In the figure, the data distribution section 51 is a processing device for evenly distributing the nozzle drive data for light ink. That is to say, the nozzle drive data is evenly distributed to the low-density buffer 37A1 corresponding to the nozzle group N1 and the low-density buffer 37A2 corresponding to the nozzle group N2.

Also, the data distribution section 53 is a processing device for evenly distributing the nozzle drive data for dark ink. That is to say, the nozzle drive data is evenly distributed to the high-density buffer 37B1 corresponding to the nozzle group N3 and the high-density buffer 37B2 corresponding to the nozzle group N4.

In this case, each of the data distribution sections 51 and 53 evenly distributes ink droplets on the basis of a distribution rule determined in advance.

For example, if the number of ink droplets given by the nozzle drive data is an even number, the value half the number of ink droplets is individually given to the corresponding two nozzle groups.

Also, for example, if the number of ink droplets given by the nozzle drive data is an odd number, the quotient of the number of ink droplets divided by two is given to one of the nozzle groups, and 1 added to the quotient is given to the other of the nozzle groups.

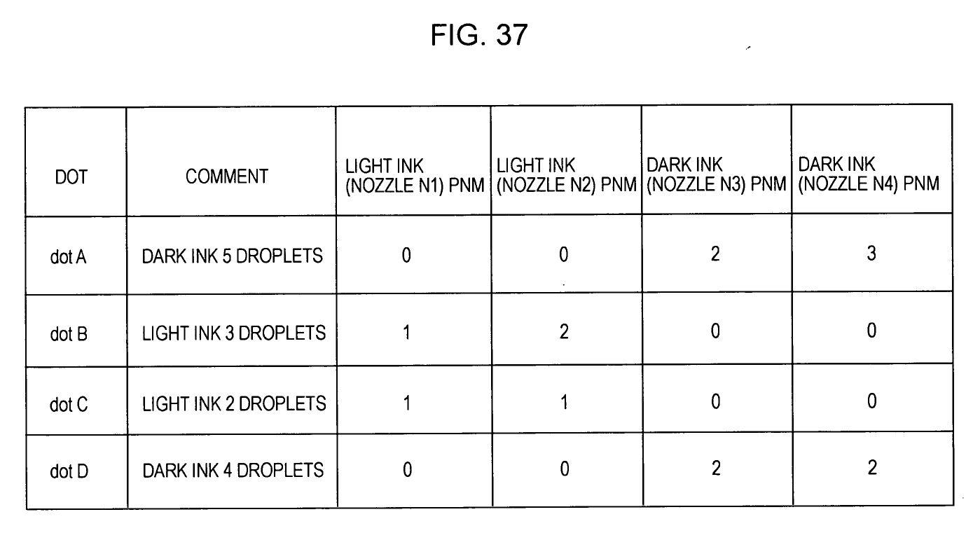

FIG. 37 is an example of output corresponding to FIG. 28(B). When such a distribution method is adopted, even if ejection malfunction occurs in any one of nozzles in the nozzle groups, that influence can be minimized, because one dot is evenly formed by the two nozzle groups.

As a result, the deterioration of the reproducing characteristic of the gradation expression can be minimized.

In this regard, in FIG. 36, a description has been given of the case where the nozzle drive data for the dark and light ink in the dot-pattern conversion section 36 is distributed. However, if ink droplets are stored in consideration of a plurality of nozzle groups at the stage of storing the data in the dot-pattern conversion section 36, it is possible to make the data-distribution section unnecessary.

(e) In the above-described embodiment, a description has been given of the case of a monochrome print mode. However, the present invention can be applied to a color print mode. In this case, a color conversion section should be disposed in place of the luminance/density conversion section.

The color conversion section is used for converting image data given as R, G, and B into three colors, yellow series, cyan series, and magenta series, which are suitable for printing.

(f) In the case of the above-described embodiment, a description has been given of the case where the nozzles are arranged at the same density as the maximum resolution along the same length as the print width in the line head.

However, the line head can be applied to the case where the line head is included in a head which is serially driven with respect to the recording medium. In this regard, a line head of this kind is also called a multi-head. In this case, the arrangement direction of the nozzles used in the description of the embodiment should be read as a main scanning direction, and the moving direction of the recording medium should be read as a sub-scanning direction.

The printer in the embodiment described above may be a print-dedicated machine or may be a combined machine. Also, the purpose of the printer is not limited to the use in an office and at home, and includes the use for medical applications. For example, the printer can also be applied to the use of printing medical images, for example, outer appearances of a patient, an X-ray images, echo images, and others.

In the above-described embodiment, a description has been given of the signal processing in the printer. However, when the signal processing in the printer is defined by firmware or an execution program, each signal processing may be achieved by software.

In this regard, the execution program is desirably stored in a semiconductor memory, a hard disk, an optical storage medium, and the other storage media.

Of course, it will be understood that various modifications may be made in the above-described embodiments within the spirit and scope of the invention. Also, various modifications and applications are thought to be devised on the basis of the description of this specification.

1. A print controller for controlling a print head having k lines of nozzle arrays or more corresponding to k kinds of (k is a natural number of two or more) ink having different densities, the print controller comprising:
a resolution determination section for determining whether print data having a resolution 1/n times (n is a natural number of two or more) a nozzle pitch has been given; and
when an affirmative result is obtained by the resolution determination section, an output-pattern allocation section for allocating, to a quantized value corresponding to each pixel, an output pattern including n-row×n-column dots and relating one of the k kinds of ink having different densities or no ejection to each dot.

2. The print controller according to claim 1, further comprising:
a distribution section for distributing data portion being partial data of the output pattern and corresponding to the k kinds of ink to the corresponding nozzle array, respectively.

3. The print controller according to claim 1,
wherein the output-pattern allocation section is disposed for each signal system of each color for color print and black.

4. The print controller according to claim 1, further comprising:
an additional-information determination section for selecting allocation of an output pattern by the output-pattern allocation section when additional information of print data having a resolution 1/n times a nozzle pitch is instructed to be printed with n times resolution;

5. A printer comprising:
a print head having k lines of nozzle arrays or more corresponding to k kinds of (k is a natural number of two or more) ink having different densities;
a resolution determination section for determining whether print data having a resolution 1/n times (n is a natural number of two or more) a nozzle pitch has been given; and
when an affirmative result is obtained by the resolution determination section, an output-pattern allocation section for allocating, to a quantized value corresponding to each pixel, an output pattern including n-row×n-column dots and relating one of the k kinds of ink having different densities or no ejection to each dot.

6. A method of print control for controlling a printer including a print head having k lines of nozzle arrays or more corresponding to k kinds of (k is a natural number of two or more) ink having different densities, the method comprising the steps of:
determining whether print data having a resolution 1/n times (n is a natural number of two or more) a nozzle pitch has been given; and
when an affirmative result is obtained by the resolution determination section, allocating, to a quantized value corresponding to each pixel, an output pattern including n-row×n-column dots and relating one of the k kinds of ink having different densities or no ejection to each dot.

7. A program for causing a computer controlling a printer including a print head having k lines of nozzle arrays or more corresponding to k kinds of (k is a natural number of two or more) ink having different densities to execute processing comprising the steps of:
determining whether print data having a resolution 1/n times (n is a natural number of two or more) a nozzle pitch has been given; and
when an affirmative result is obtained by the resolution determination section, allocating, to a quantized value corresponding to each pixel, an output pattern including n-row×n-column dots and relating one of the k kinds of ink having different densities or no ejection to each dot.

8. A data structure of an output pattern used at the time of printing by a print head having k lines of nozzle arrays or more corresponding to k kinds of (k is a natural number of two or more) ink having different densities, the data structure comprising:
as an output pattern to be allocated, to a quantized value corresponding to each pixel of print data having a resolution 1/n times (n is a natural number of two or more) a nozzle pitch,
a relationship of each dot included in n-row×n-column dots with one of the k kinds of ink having different densities or no ejection to each dot.

9. A method of generating a dot pattern comprising the steps of:
in the case of using, as an output apparatus, a print head having k lines of nozzle arrays or more corresponding to k kinds of (k is a natural number of two or more) ink having different densities,
when one pixel is formed by a group of n-row×n-column dots having a resolution 1/n times (n is a natural number of two or more) a nozzle pitch, and each of the dots is formed by ejecting a maximum of m (m is a natural number of two or more) droplets of ink in piles,
relating a density expression of a maximum of m+1 gradations by one of the k kinds of ink to each dot; and
relating a density expression given by a combination of all the groups of the n-row×n-column dots to all density-input values.

10. A method of printing comprising the steps of:
in the case of using, as an output apparatus, a print head having k lines of nozzle arrays or more corresponding to k kinds of (k is a natural number of two or more) ink having different densities,
when one pixel is formed by a group of n-row×n-column dots having a resolution 1/n times (n is a natural number of two or more) a nozzle pitch, and each of the dots is formed by ejecting a maximum of m (m is a natural number of two or more) droplets of ink in piles,
relating a density expression of a maximum of m+1 gradations by one of the k kinds of ink to each dot; and
from a data table relating a density expression given by a combination of all the groups of the n-row×n-column dots to all density-input values, reading a dot pattern corresponding to the density-input value.

11. A print controller for forming one pixel by a group of n-row×n-column dots having a resolution 1/n times (n is a natural number of two or more) a nozzle pitch, and forming each of the dots by ejecting a maximum of m (m is a natural number of two or more) droplets of ink in piles in the case of using, as an output apparatus, a print head having k lines of nozzle arrays or more corresponding to k kinds of (k is a natural number of two or more) ink having different densities, the print controller comprising:
a gamma correction section for performing gamma correction on density data corresponding to each pixel and outputting the density data;
a dot-pattern reading section for relating a density expression of a maximum of m+1 gradations by one of the k kinds of ink to each dot,
and reading a dot pattern corresponding to the density data after the gamma correction from a data table relating a density expression given by a combination of all the groups of the n-row×n-column dots to all density data; and
a data-distribution section for distributing a pattern for each nozzle array corresponding to each dot pattern to each nozzle.

12. The print controller according to claim 11, further comprising:
a gradation-width restriction section for restricting a gradation width of density data corresponding to each pixel at a prior position to the dot-pattern reading section in order for the gradation width to fall into an input gradation width of the data table.

13. The print controller according to claim 11, further comprising:
a gradation-width conversion section for converting a gradation width of density data corresponding to each pixel at a prior position to the dot-pattern reading section in order for the gradation width to fall into an input gradation width of the data table.

14. A printer comprising:
a print head having k lines of nozzle arrays or more corresponding to k kinds of (k is a natural number of two or more) ink having different densities; and
a print control section for forming one pixel by a group of n-row×n-column dots having a resolution 1/n times (n is a natural number of two or more) a nozzle pitch, and forming each of the dots by ejecting a maximum of m (m is a natural number of two or more) droplets of ink in piles,
wherein the print control section includes:
a gamma correction section for performing gamma correction on density data corresponding to each pixel and outputting the density data;
a dot-pattern reading section for relating a density expression of a maximum of m+1 gradations by one of the k kinds of ink to each dot,
and reading a dot pattern corresponding to the density data after the gamma correction from a data table relating a density expression given by a combination of all the groups of the n-row×n-column dots to all density data; and
a data-distribution section for distributing a pattern for each nozzle array corresponding to each dot pattern to each nozzle.

15. A printer comprising:
a print head having k lines of nozzle arrays or more corresponding to k kinds of (k is a natural number of two or more) ink having different densities; and
a print control section for forming one pixel by a group of n-row×n-column dots having a resolution 1/n times (n is a natural number of two or more) a nozzle pitch, and forming each of the dots by ejecting a maximum of m (m is a natural number of two or more) droplets of ink in piles,
wherein the print control section includes:
a gamma correction section for performing gamma correction on density data corresponding to each pixel and outputting the density data,
a gradation-width restriction section for restricting density data after the gamma correction in order to fall into an input gradation width of a data table positioned at a subsequent stage,
a dot-pattern reading section for reading a dot pattern corresponding to the density data after the gamma correction from a data table relating a density expression given by a combination of all the groups of the n-row×n-column dots to all density data, and
a data-distribution section for distributing a pattern for each nozzle array corresponding to each dot pattern to each nozzle.

16. A printer comprising:
a print head having k lines of nozzle arrays or more corresponding to k kinds of (k is a natural number of two or more) ink having different densities; and
a print control section for forming one pixel by a group of n-row×n-column dots having a resolution 1/n times (n is a natural number of two or more) a nozzle pitch, and forming each of the dots by ejecting a maximum of m (m is a natural number of two or more) droplets of ink in piles,
wherein the print control section includes:
a gamma correction section for performing gamma correction on density data corresponding to each pixel and outputting the density data,
a gradation-width conversion section for converting density data after the gamma correction in order to fall into an input gradation width of a data table positioned at a subsequent stage,
a dot-pattern reading section for reading a dot pattern corresponding to the density data after the gamma correction from a data table relating a density expression given by a combination of all the groups of the n-row×n-column dots to all density data, and
a data-distribution section for distributing a pattern for each nozzle array corresponding to each dot pattern to each nozzle.

17. A program for causing a computer to execute processing as a print controller, the processing comprising the steps of:
in the case of using, as an output apparatus, a print head having k lines of nozzle arrays or more corresponding to k kinds of (k is a natural number of two or more) ink having different densities,
when one pixel is formed by a group of n-row×n-column dots having a resolution 1/n times (n is a natural number of two or more) a nozzle pitch, and each of the dots is formed by ejecting a maximum of m (m is a natural number of two or more) droplets of ink in piles,
relating a density expression of a maximum of m+1 gradations by one of the k kinds of ink to each dot; and
reading a dot pattern corresponding to the density-input value from a data table relating a density expression given by a combination of all the groups of the n-row×n-column dots to all density-input values.

18. A data structure of a dot pattern comprising:
in the case of using, as an output apparatus, a print head having k lines of nozzle arrays or more corresponding to k kinds of (k is a natural number of two or more) ink having different densities,
when one pixel is formed by a group of n-row×n-column dots having a resolution 1/n times (n is a natural number of two or more) a nozzle pitch, and each of the dots is formed by ejecting a maximum of m (m is a natural number of two or more) droplets of ink in piles,
relating a density expression of a maximum of m+1 gradations by one of the k kinds of ink to each dot; and
relating a density expression given by a combination of all the groups of the n-row×n-column dots to all density-input values.
